(19) United States
(12) Patent Application Publication
(10) Pub. No.: US 2026/0278478 A1
(43) Pub. Date: Sep. 17, 2026

(54) RAG AND REMINDER RINGS: SURFACING MEMORIES FOR HUMANS AND LLMS

(71) Applicant: CONVERSATION PROCESSING INTELLIGENCE CORP., BELLEVUE, WA (US)

(72) Inventors: RICHARD LEEDS, BELLEVUE, WA (US); ELON GASPER, BELLEVUE, WA (US)

(21) Appl. No.: 19/167,108

(22) PCT Filed: Mar. 24, 2024
(86) PCT No.: PCT/US2024/021259

§ 371 Date: Sep. 19, 2025

(51) Int. Cl. G06N 20/20; G06F 40/30

(52) U.S. Cl. CPC G06N 20/20; G06F 40/30

(57) ABSTRACT

A system and method for collaborative Al, machine learning units, macrocellular automata, and experience chain processing integrated with RAG and ReminderRing technology. The invention seeks to make Collaborative Conversational AIs (CCAIs), such as those used in conversational digital personal assistants, more productive, collaborative, and useful in Notification Selection based on context and experience. The invention includes further methods and apparatus relating to topics within the context of intelligent software agents, including modern conversational LLMs, as well as persuadable AIs, machine learning units, and machine learning by experience.

### CROSS-REFERENCE TO RELATED DOCUMENTS

This application claims priority to U.S. Provisional Patent Applications 63/492,158, 63/509,019, 63/588,276, and 63/552,828. This application makes reference to U.S. Pat. No. 11,431,660 (hereafter, the '660 patent), U.S. Pat. No. 11,277,512 (hereafter, the '512 patent), and U.S. patent application Ser. No. 17/869,700 (hereafter, the '700 application), submitted by the current application's inventors. All of the above are hereby incorporated by reference as if fully set forth herein.

### COPYRIGHT STATEMENT

All material in this document, including the figures, is subject to copyright protections under the laws of the United States and other countries. The owner has no objection to the reproduction of this document or its disclosure as it appears in official governmental records. All other rights are reserved.

### TECHNICAL FIELD

The present invention relates generally to large language models (LLMs), retrieval-augmented generation (RAG), collaborative artificial intelligence, persuadable AI, conversational AI, collaborative conversations, collaborative conversational AI(CCAI), experience recording, experiential memory, intelligence aggregation and augmentation, machine intelligence aggregation, machine learning units(MLUs), experiential machine learning, machine decision making and responses, computing, automated natural language conversation, conversation processing, conversational interactions, natural language processing, natural language understanding, natural language invoked skills, natural language creation, theory of mind, persuadable systems, conversation evolution, collaboration skills, collaboratorial evolution and representations of doxastic cogitation, and optional human-in-the-loop systems.

### BACKGROUND

The '660 patent disclosed a method for collaborative conversational artificial intelligence (CCAI) including an architecture wherein members of the system participate in collaborative conversations with one or more AIs and human “subminds” connected via a forum, including conversing in natural language and facilitated by one or more “facilitators”.

The '700 application disclosed persuadable collaborative conversational AI including a system and method for “Decidrons”, which are units of machine learning that can be grouped together to provide collaborative widely extensible evolving modular polylogical groups. The invention utilizes stages of cogitation, persuadability and theory of mind to improve and extend the collaborative conversational artificial intelligence (CCAI) disclosed in the inventors' prior patent applications.

The '512 patent disclosed a method for computer control of online social interactions based on conversation processing, in particular a system and method for scoring and selection of communication notification presentation through contextual feedback, in particular where a portion of a conversation with a given user is recorded, stored in memory, and processed so as to influence subsequent interactions, and in particular to reconvey recorded content as a contextual reconveyance. For example, these may include audio excerpts or other contextualized annunciations of subsequent telephone calls.

Since the filing of these previous inventions, the rapid development and widespread adoption of large language models (LLMs) have transformed the AI landscape. LLMs, with their vast knowledge bases and advanced natural language processing capabilities, have unlocked new possibilities for intelligent systems that can engage in more human-like conversations, draw insights from massive amounts of data, and adapt to a wide range of contexts. The integration of RAG, Retrieval-Augmented Generation, into AI systems has also been particularly impactful in the development of conversational agents and question-answering systems, allowing these systems to dynamically retrieve and incorporate relevant information from external sources, leading to further improvements in their quality and usefulness. CCAIs and RAG achieve cumulative results, not averaging. These advancements have been accelerated by the lack of cost-effective alternatives for incremental training and combining of Als and databases.

The present invention builds upon the foundations of the '660 and '700 patents, integrating LLMs and other advancements to extend the capabilities and application scope of CCAIs and Decidrons. By leveraging LLMs, the present invention enables more natural and efficient collaboration among AI subminds, enhances the persuadability and adaptability of these systems, and unlocks new possibilities for intelligent notification, context-aware decision-making, parallel MLU computing, multidimensional MLU computing, improved reliability, human-AI interaction, AI human augmentation and human AI hybrids.

Moreover, the present invention introduces novel techniques for natural language multi-modal conversation tracking, visualization, and simulation (e.g. for refinement and reinforced learning), which improve notifications and collaborations, while dramatically enhancing the interpretability, transparency, auditability, and controllability of CCAI-driven systems.

These advancements are crucial for building trust and alignment with human values and safety, especially as AI systems become more deeply integrated into critical domains such as healthcare, finance, and industrial control.

The glossary included herein contains many terms used in this specification. However, to assist the reader, some of the more critical terms include MLU (Machine Learning Unit), CCAI (Collaborative Conversational AI), Experience Chain (EC), Decidron, ECDS (Experience Chain Data Structure), RAG (Retrieval-Augmented Generation)and Macrocellular Automata.

The present invention seeks to make Collaborative Conversational AIs (CCAIs), such as those useful for conversational digital personal assistants, expert systems, automated training, command, control, and communications (C3) systems, image processing, more efficient, productive, collaborative, and useful in Notification Selection and use in MLU interaction (supplementing the material disclosed in the '512 patent) based on context and experience. While the notification selection system provides a valuable embodiment integrating CCAI conversational interfaces and machine learning expertise for contextual recommendation at a high level, at a lower level CCAI/MLU integration offers significant advantages common across domains by enabling flexible arrangement and rearrangement of specialized modules. Key high-level benefits include improved distributed processing efficiency via modular components, expanded learning capacity through restructuring of expertise, and resilience against individual subsystem failures.

Herein are further methods and apparatus relating to those topics within the context of intelligent software agents, including modern conversational LLMs, as well as persuadable AIs, machine learning units, and machine learning by experience.

### BRIEF SUMMARY OF THE INVENTION

The present invention improves CCAI implementation and performance by extending prior systems to provide additional innovations. The introduction in the '700 application of Decidrons, a machine learning unit (MLU) programmed with collaborative protocols enabled coupling into dynamic and extensible ensembles capable of aggregating expertise and expanding human and machine operations capabilities. Beyond conversational queries and responses, the present invention discloses integrating MLU networks with real-time sensors and actuators enables addressing industrial controls, information technology security oversight, and reliability through parallel pathways. Moreover, large language models (LLMs) can simulate CCAI, and other collaborative intelligence systems, to enable efficient compilation into optimized implementation ensembles that aggregate learning and generative capacity across technology platforms.

The present invention integrates Collaborative Conversational Artificial Intelligence (CCAI), Large Language Models (LLMs), Generative Pre-trained Transformers (GPT), Retrieval-Augmented Generation (RAG), and modular Machine Learning Units (MLUs), supported by enhanced Experience Chain Data Structures (ECDS) along with novel conversation matrix display techniques and other technology for combining, correlating, sharing and securing processed. While the CCAI/MLU architectural paradigms introduced here have broad applicability, the notification delivery embodiment supplied by the '512 patent provides a compelling demonstration integration. In one case of that integration, sensory and contextual inputs fuel a Feedback Management System CCAI to select the most pertinent and reliable notifications. The overall effect of these combinations is to yield improved systems with multiple advantages:
Enhanced performance of CCAI-based systems by combining collaborative protocols in MLUs with expertise aggregation enabled by integrating across multiple technology platforms
Improved collaborative functioning through coupling ensemble networks of MLUs and CCAIs
Flexible connection of collaborator components by networking MLUs
More efficient processing of collaborative interactions between machine learning components by integrating MLUs
Expanded machine learning capacity through evolutionary restructuring, rearrangement and recruitment of expert MLUs and CCAIs across dispersed systems
Smarter, more adaptable and more reliable industrial control processes through coordination of MLUs both monitoring real-time systems status and managing actuator response pathways
More robust information security by utilizing MLUs to provide parallel pathway redundancy

### BRIEF DESCRIPTION OF THE DRAWINGS

FIG. 1 shows the notification architecture from the '512 patent, which depicts a conversational Notification Selection and Scoring System.

FIG. 2 shows a CCAI abstraction. The 7-point star icon will be used in other figures to represent a CCAI.

FIG. 3 is a simplified version of FIG. 1 showing the area of focus for the present invention-notification and the feedback management system (5600).

FIG. 4 adds to FIG. 3 showing a CCAI in the Feedback Management System.

FIG. 5 adds further to FIG. 3 showing direct connections to the scoring system (5200), the system evaluator (5602), and notification data parameters (5608).

FIG. 6 adds further to FIG. 3 showing how one member of the CCAI acts as the facilitator where all communications go through that member.

FIG. 7 adds further to FIG. 3 showing a separate facilitator to interface with an AI such as an image or audio generator, including a generative adversarial network (GAN).

FIG. 8 adds further to FIG. 3 showing the feedback management system using another CCAI as that image generator AI or as a shell around one or more others.

FIG. 9 shows the same sort of CCAI structure used for other applications than notification; for example, AI prompts, including not just text but images, videos, etc., can be the target or the refinements (as proposed by the CCAI members) or both.

FIG. 10 shows that the entire system or parts thereof can be simulated by prompting LLM (or a CCAI containing or acting as an LLM) to enact multiple members, or even simulate the whole process, potentially including facilitators including a Proctor, for advantages of diverse points of view and robust failure resistance. They all exist within the LLM, as if in a theater of its imagination, or like a hypervisor emulating multiple virtual machines or servers.

FIG. 11 shows that humans may be included in CCAI(s); and the external application may not be a conversation with a human, but some other application, as previously disclosed. As a black box it just has multiple participants. They may come and go, summoned into connectivity by recruitment facilitator, etc. The AI participants likewise, as previously disclosed, but summoned into virtual existence on demand in the sim.

FIG. 12 shows how, for faster execution, or other reasons, including adding sensor and actuator interconnections, instead of running in simulation, LLM can be prompted to write code, instantiate and/or deploy a faster version of the CCAI system, and may use spare cycles to optimize CCAI participants, update training data as available, and machine reinforcement learning through analysis of experience.

FIG. 13 shows how, for faster execution, or other reasons, instead of running in simulation, LLM can be prompted to write code, instantiate and/or deploy a faster version of the system. This can also be done with a CCAI shell for the standard advantages, or because necessary (for instance, to have humans involved)

FIG. 14 is background on CCAIs, basic ToM determination by behavioral pattern matching of actual with simulated experience.

FIG. 15, adds to FIG. 14 to show how other AI components can be included and utilized.

FIG. 16 provides a table of example MLU types, their use, and organizing principle.

FIG. 17 shows a Decidron pipeline architecture for collaborative cogitation, formative to decision, action and posited action by CCAIs using experience chains data structures.

FIG. 18 is an extension of FIG. 17 a Decidron pipeline.

FIG. 19 shows Experience, Experience Repositories and ECDS processing with Participant Selection, Simulation, Inference, Scoring, Iteration, Decidron CCAI Deployment Facilitator and additional implementation context and details.

FIG. 20 shows additional ECDS processing implementation context/detail added to FIG. 19: including how other embodiment AI components such as CCAIs with LLMs and other MLUs can be included and utilized, plus generalized to other MLUs that use similar flow.

FIG. 21 shows an alternate conversation and collaboration tracking chart paradigm, a spreadsheet of discussion phases and results, to make it easier to assess and evolve conversational Als, their forms and members.

FIG. 22 is an alternative rendering format with arrows showing which participants finally voted for which, what the prompt was, and who “won” the collaboration.

FIG. 23 shows a CCAI (F′ Forum) as a participant nested in another CCAI (F Forum). The nested CCAI F′ Forum includes a nested human participant Natural Language external conversation.

FIG. 24 illustrates integrating the conversational Notification Selection and Scoring System (NSS), shown in FIG. 1 (with added detail in other Figures), to improve notifications of an External Application User, via a contextual notification ring. Integrating an application and communicating with an External User is facilitated by a CCAI proctor operating as a member of CCAI F′ Forum. Submind U is the “user” of the notification system. The graphic in FIG. 24 represents FIG. 1, and its integration of the NSS in CCAI systems.

FIG. 25 illustrates using Notification Selection and Scoring System (integrating FIG. 1) to improve notifications of CCAI member—adding a separate notification facilitator for partial (split) Notification Scoring and Selection System management. Here Submind U participates in the forum while the Facilitator helps manage the notification system interactive functionality.

FIG. 26 illustrates using Notification Selection and Scoring System (integrating FIG. 1) to improve notifications of CCAI members with a separate facilitator mediating a submind's Notification Scoring & Selection functionality.

FIG. 27 illustrates using Notification Selection and Scoring System (integrating FIG. 1) to improve notifications of CCAI members-separate multiplexed facilitator mediating all of two subminds' Notification Scoring & Selection functionality.

FIG. 28 shows how CCAIs can have images (or video, code, other) in prompt and/or response, including semi-supervised machine learning. Here a specialist CCAI with human subjects reviews potential design images and relays reactions and interpretation into the art and image generators & assessment CCAI, which includes a Prompt Engineering submind to help focus the GenArtAIs on incorporating the test consumer feedback. Note that for an LLM, the submind is integrated as described in CCAI patent, with the BCN labeling reflecting modes of data flow to and from F. Conduit can have API or other parameter structuring for LLM, such as ‘temperature’. “Natural Language Understanding” can be an LLM which accepts multi-modal prompts.

FIG. 29 shows a CCAI submind with Basic Chat Intelligence Proposer, NLU Appraiser and Discusser, from the '660 patent.

FIG. 30 extends FIG. 29 with LLMs replacing or augmenting components.

### DETAILED DESCRIPTION OF THE INVENTION

Collaborative Conversational AIs (CCAIs) are capable of transparently incorporating multiple intelligences, both human and artificial, and more flexibly addressing problem sets presently addressed by less flexible AI techniques.

Key to the utility of advanced CCAI utilization is the application of Machine Learning Units (MLUs) and their associated Experience Chain Data Structures (ECDSs). The use of ECDSs within the CCAI and MLU architecture enables efficient storage and retrieval, and contextual real time processing of linked event data for real time contextual responses. By organizing experiential information into chronological chains, in an embodiment, ECDSs facilitate rapid simulation and inference of hypothetical scenarios. This allows the collaborative CCAI-MLU-ECDS ensemble to draw upon past experiences and project potential outcomes when making decisions or generating responses.

The nested and dynamic connections of MLUs, supported by Experience Chain Data Structures, enable them to effectively create layers of processing comparable to macrocellular automata. Whereas elementary cellular automata studied by Wolfram (1983) consist of simple cells following set rules, the automata-like networking of MLUs leverages more flexible software components. Just as multicellular organisms grow layers of specialized cells forming macroscopic organs, ensembles of MLUs can self-organize into macrostructures handling higher-order cognition. Certain MLU groupings provide topological separation enabling modular functionality; others yield integrative synergies through relatively microscopic notification protocols among MLUs. Much like biological cells, aging or underperforming MLU components may be isolated and recycled to maintain systemic efficiency. The multi-pathway architectures illustrated for Decidrons integrate MLU microprocessing with experience chain knowledge and real-time data to produce responsive, resilient decisions. In effect, the dynamic assembly of MLUs gives rise to emergent macroscale automation with adaptive learning.

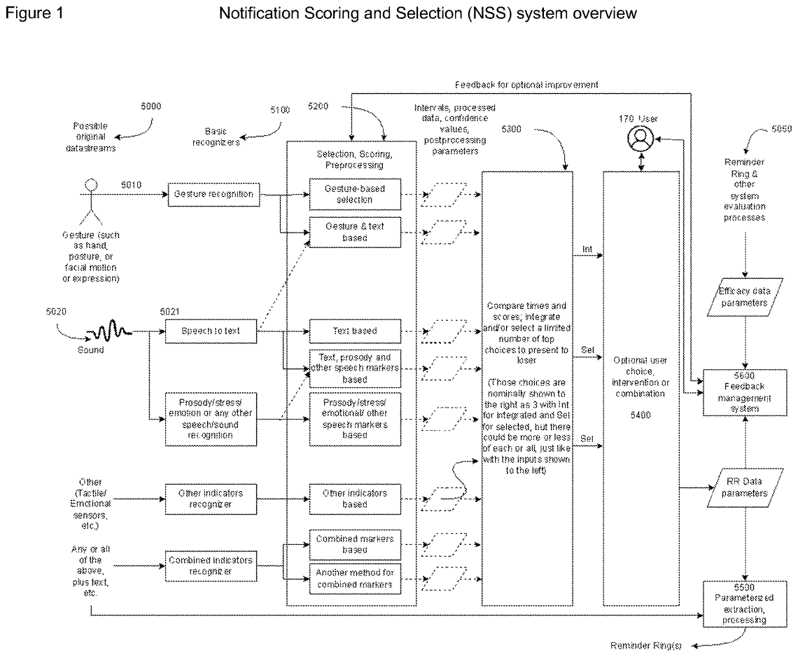

One application of this technology is to optimize the delivery of notifications to users, as addressed in the '512 patent. In that context, as an embodiment seeking to fulfill the need for component (5600) (see FIG. 1, reproducing FIG. 51 of the '512 patent), the Feedback Management System, CCAIs may be used, and thus the combined systems improved and able to enlist human intelligences within their functioning.

Optimization of the performance of such systems, including by improved selection of such notifications through scoring and AI-assisted selection, is taught in the '512 patent. (see '512, column 34 line 44 through column 36 line 36). In the present invention, the Feedback Management System (5600) is extended, in particular, by utilizing a CCAI in its operation. In addition, other parts of the process can be augmented with CCAIs or parts thereof such as Decidrons, and other MLU components.

Another key innovation in the present invention is the ability to chain and link ECDSs for enhanced machine learning by these extended MLU components. By connecting related Experience Chains to them and each other, the system can identify patterns and correlations that might otherwise go unnoticed. This enables a CCAI to make more informed decisions by considering a broader context of relevant experiences. Furthermore, the linking of ECDSs allows for the creation of complex, multi-dimensional data structures that can capture nuanced relationships between events and decisions.

The '512 patent provided a variety of examples for how the sound, or other notification modalities, such as text display, image(s) or video, could be selected for extraction out of a communications conversation, and subsequently processed to improve effectiveness. Revisiting this to set the stage for the present invention's novel improvements, FIG. 1 (5100) matches each source data stream with one or more initial processes that digitize and perform feature recognition on each data stream. These processed and/or feature-recognized streams are then output to (5200) which consists of the next stage of processes, each of which takes one or more of the preceding (5100)'s outputs and creates a proposed ReminderRing from it, with additional data, such as a confidence, collaboratarial and score. This proposed ReminderRing is then output into comparator/integrator (5300), which may present a more limited number of choices of ReminderRings to the user (170) or automatically chooses one itself. Evaluation (5050) of the outcome of the chosen ReminderRing provides feedback to improve the ReminderRing.

Continuing in FIG. 1, next is basic recognition for sound (5020). Here, by way of example, any of the data streams from column (5000) can have multiple independent recognizers applied to them. Methods for both speech to text and for extracting other information from sounds, including speech sounds, are generally known in the art; the notification selection patent noted examples such as Praat and Sphinx code, but many advanced facilities are now available commercially and well known in the art, ranging from Google and Amazon's cloud-based speech-to-text (STT) and text to speech (TTS) services to edge device resident code from Neon.ai, including in directories aggregated and/or hosted at Hugging Face.

Column (5200) of FIG. 1 illustrates modules which take the input data streams of column 5100 and processes them to select, extract, preprocess and score potential ReminderRings. Each of these modules takes in the output from one or more basic recognizers, identifies and analyzes them, and on that basis specifies a potential ReminderRing, as well as a self-evaluation score reflecting the degree of confidence it has in that judgment. That confidence score could range from a simple binary indicator of “found it” versus “didn't find it”, to an elaborate matrix evaluation function. For an example, the confidence score is taken as a single scalar quantity, which could be normalized to produce a number from 0 to 10, where 10 designates a seemingly ‘perfect’ ReminderRing had been found or derived.

Next is the other indicators-based module. An example application might involve the GPS locator on a phone. Additional information may be made available to the basic recognizers of column (5100) or subsequent processors such as the modules of (5200) that enable the subsequent processors to access a system of identification and memory of who is talking so as to vary parameters and adjust to individual habits of communications, languages, and contexts.

Continuing, in column (5250) of FIG. 1, there are outputs from the modules of (5200), each providing data specifying its selection or derivation of a ReminderRing. This data could include, for example: a whole set of time intervals for the conversation; postprocessing parameters, for instance, telling how those were to be concatenated and smoothed; already processed data such as a speech recording formed by text-to-speech from instant messaged text; and confidence indicators as previously mentioned. For an example, a single interval is specified by a start time and a length in seconds, plus a positive number indicating confidence. These values are given as inputs to the comparator/integrator function (5300).

Comparator (5300) compares its inputs and selects one or more among them to use or seek user (170) consultation regarding, and/or it can integrate their recommendations. More elaborate mechanisms were described in the '512 Notification Selection patent.

Receiving these several inputs defining possible ReminderRings, a function (5400) presents the possible ReminderRings to the user (170) to choose among, either at the end of the call, or later, as subsequent function. Function (5400) can also allow the combination of ReminderRings through means such as concatenation or rotating and/or random usage. These modes can be user (170) selected, resulting ReminderRing and related data, and/or possibly parameters defining its generation (for instance, at its simplest, the time interval instead of the actual sound) are passed to function (5500) that renders them into form suitable for the actual ReminderRing system. The notification candidate and related data are also passed to a Feedback Management System (5600).

Feedback Management System (5600) gauges the effectiveness of the selected notification by a variety of means, which may, but need not, include user evaluation, efficacy judged externally (for example, through customer surveys, project reporting metrics, medical compliance measurements, and call-answering frequencies, among others) and the results used for adjustment and of the Scoring and Selection modules of column (5200) to produce better future results. Feedback Management System (5600) may use interactive parametric adjustments by the user (170), or techniques known in the art such as artificial intelligence, artificial evolution and neural networks. As an example, the '512 Notification Selection patent mentions Praat open source software program source code Feedforward Neural Network learning and classification functionalities may serve as a basis for performing neural network functions within this Feedback Management System (5600).

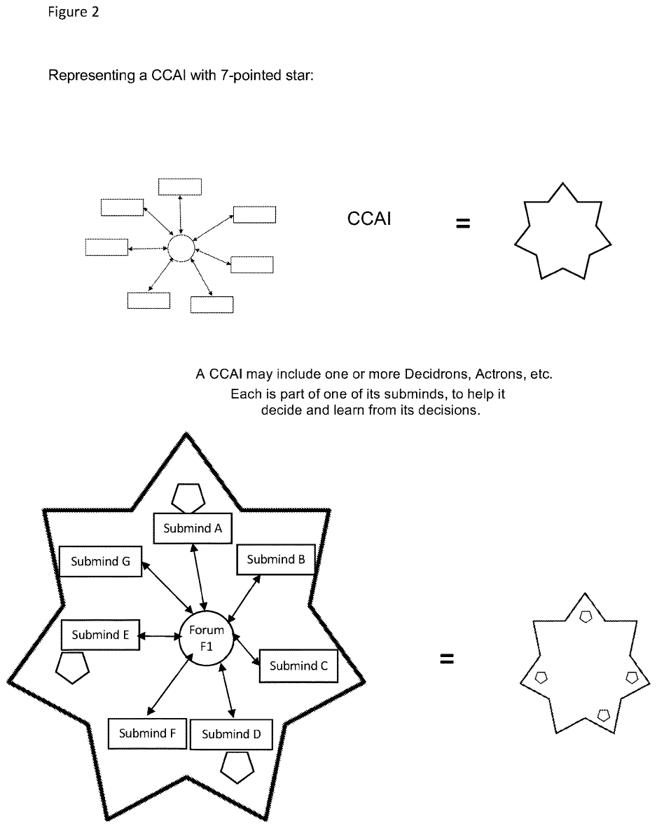

In the present application (see FIG. 1) we extend FIG. 51 from the '512 patent to CCAIs, LLMs, and other MLUs, showing additional value results. FIG. 2 illustrates how subminds may contain such components, Decidrons in particular, though other MLU possibilities, including Actrons, are also potential components. FIG. 2 shows a CCAI as a star shape and a submind as a pentagon with the pentagons scattered to indicate the potential construction and nesting symbolically without limitation.

Consistency, flexibility and adaptivity are valuable in collaborative endeavors. Persuadability is a type of adaptivity of particular value in a collaborative conversation. To optimize its utility, persuadable AI needs to express adaptivity by learning from experience. That ability needs to include both real world and predicted or projected results and be able to map them to decisions about how to adapt to them based on persuasive evidence and interpretation. To that end, in the '700 application the present inventors disclosed a system, the Decidron, capable of learning from and through experience, and engaging in support of collaboration, including by utilizing CCAIs within itself. The Decidron is a type of Machine Learning Unit (MLU). In the CCAI lexicon, MLUs are basically modular software or hardware components focused on specialized machine learning tasks.

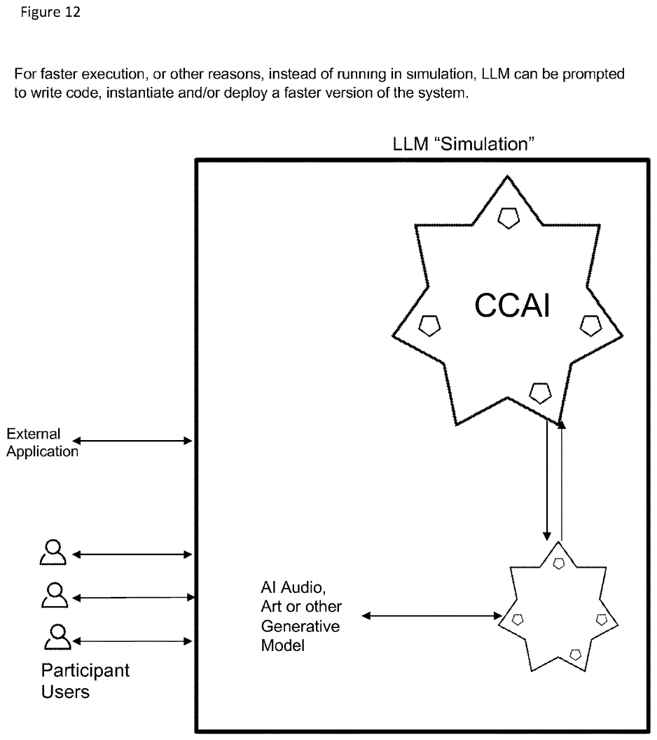

FIGS. 12-15 of the '700 application portrayed some examples of integration of Decidrons and CCAIs. FIG. 2 includes a rendering of a CCAI with seven subminds, three of which have Decidron assistance, which will be utilized herein to represent any CCAI, any of whose members may have any number of assistance modules.

### Notification Selection Architecture Innovation: Applying CCAI, LLM & MLUS

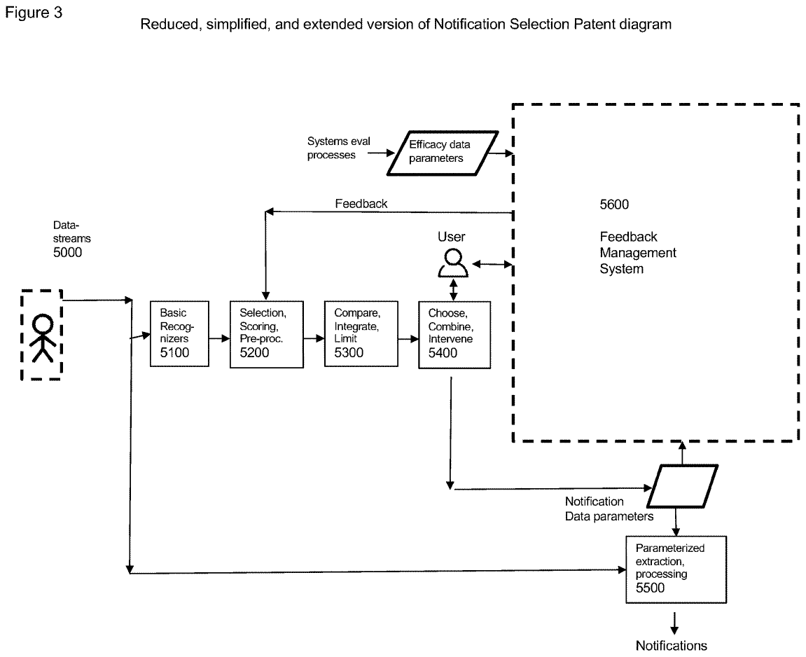

The application of Decidrons and their integration within CCAI and MLU architectures extends to various domains, including the optimization of notification delivery to users, as addressed in the '512 patent. Turning now to FIG. 3, an alternate, simpler version of the present application's FIG. 1 diagram is presented, which will serve as a template to illustrate the Feedback Management System and other components, configurations and architecture as innovations are added in subsequent figures to extend and reconfigure it.

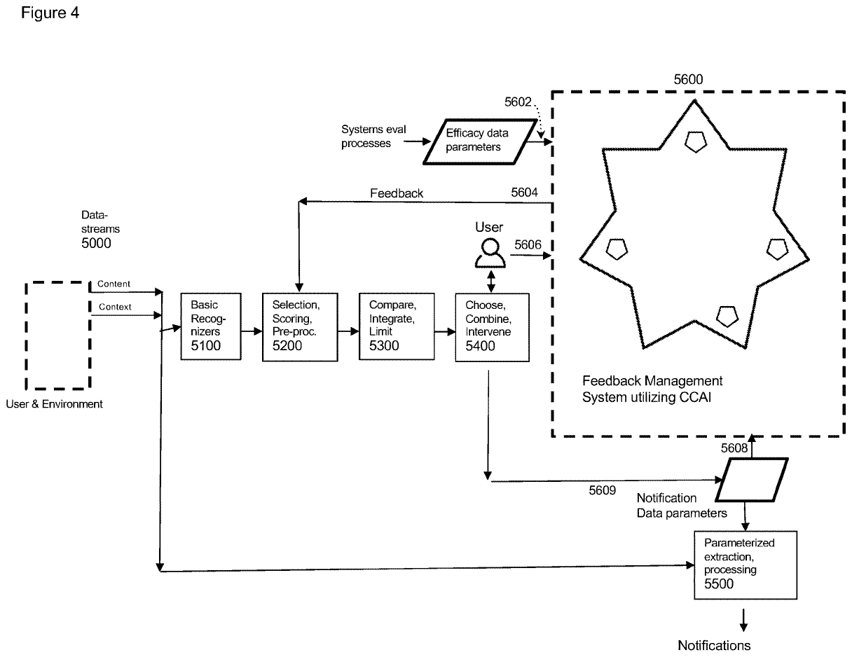

In one case this Feedback Management System may utilize or more directly be replaced by a CCAI. See FIG. 4, which remains organized starting on the left with a column (5000) depicting data streams of various possible source and triggering inputs for ReminderRings. Additionally, in this case the data streams (5000) have been generalized and characterized as two types: Content, which includes gestures, speech, text, tactile and other user-driven inputs; and Context, which includes ambience such as background sounds. To better illustrate and support this distinction of Content and Context, plus the potential for diverse, even nonhuman users, the stick person and the adjacent images on the left column have been replaced with the words “User and Environment”. Note that even with a human user, the Context category might also include user-generated inputs that are not consciously determined: for instance, the emotional state sensor data stream(s) that were shown in FIG. 1.

Continuing now with FIG. 4, it shows that component (5600) may contain a CCAI. It also labels the four communication channels (shown also in FIG. 1) connecting to (5600) as (5602), (5604), (5606), and (5608); plus labels (5609) the data parameters conveyed between (5400) and both (5500) and (5600).

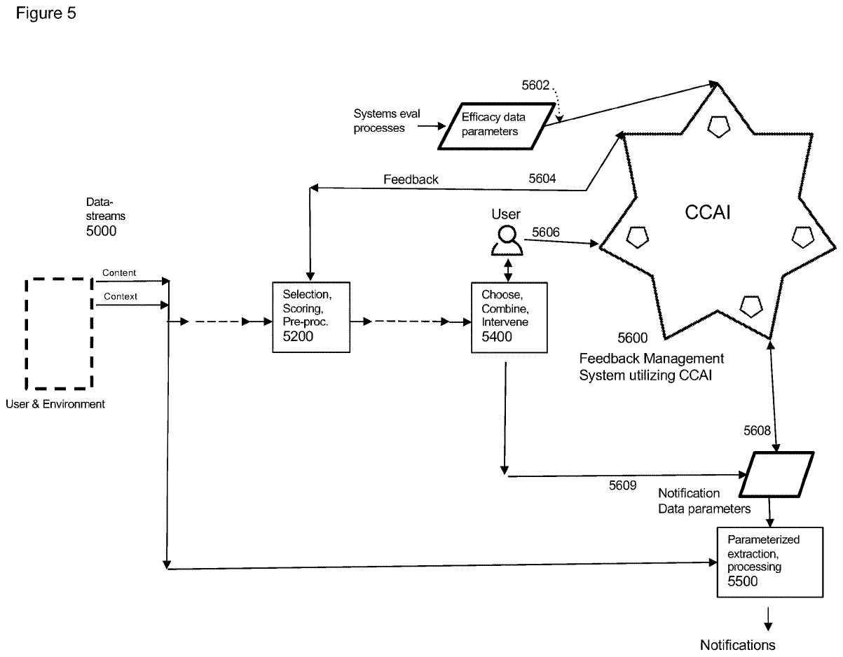

In order to illustrate this latter point and make simpler diagrams to add to it to better teach through embodiments of the present invention, FIG. 5 then compresses FIG. 4, zooming out by eliding components (5100) and (5300). It also explicitly portrays the (5600) component as a CCAI itself, an even simpler case. It will be apparent to one with skill in the art that it is unlikely that specifics of implementation would get by with little or no interfacing ‘glue’, but that's left out of the diagram for teaching's sake. FIG. 5, for similar reasons, also further preferences an embodiment where separate CCAI members, represented without limitation by the points on the star, access the aforementioned channels of communication, with their data parameters and any other content.

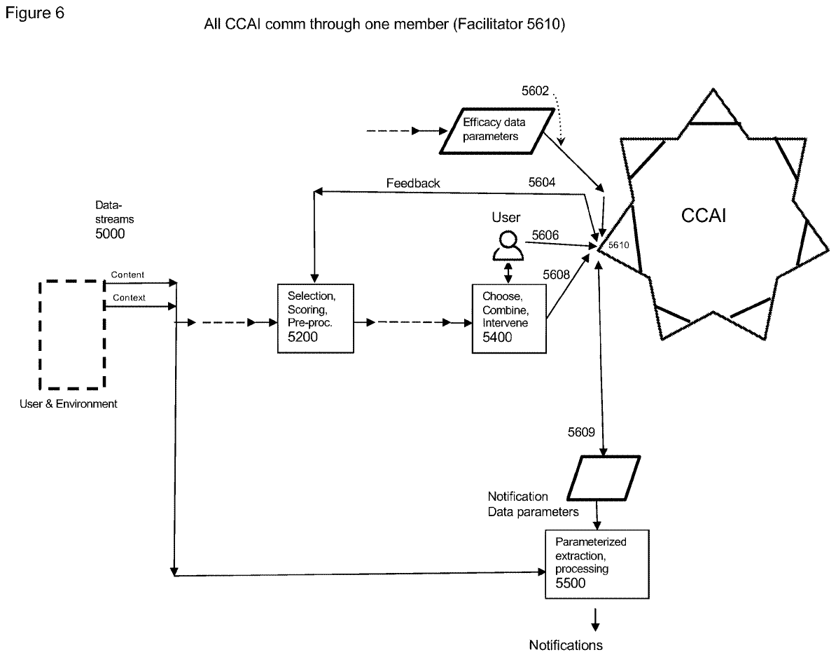

Next, in FIG. 6 the label for Systems Eval Processes has also been elided as part of zooming out further, plus showing that all those (5600) Feedback Management System couplings can alternatively aggregated to a single point of participation with the CCAI, where a Facilitator (5610) is included for that purpose. This configuration is depicted here without limitation by separating the point to represent that Facilitator within the CCAI. The other potential MLUs have been elided for clarity in this portrait, but may still be present, as described in '700 and extended later in this document. FIG. 6 also shows that in this single-point-of-connection configuration, Notification Data Parameters (5608) can be more directly aggregated by the Facilitator (5610) itself.

The '660 patent and the '700 application taught useful new art in areas for CCAI in external conversation and in external applications, for example, industrial control systems applications. Both conversations and applications included potential use of persuadable AIs, examples of which were provided. These Als were able to be influenced by discussion and other communication, and to be persuaded as a result. Prior AI implementations had not only failed to address this need, but even promoted and advocated for the opposite traits. But as cited in '700, that disclosure laid out evidence that persuadability is a rich aspect of intelligence and thus of utility in its emulation in AI, with potentially deep and previously unaddressed utility in its own right, able to produce better outcomes.

The perception in the art of the utility of AI persuadability has undergone a transformation in the time since that the '700 application was filed. AIs such as LLMs are now being described matter-of-factly as needing to be persuaded, and speculation occurs about hypothetical AIs where internal parts of them persuade other parts of them. A collaborative conversational AI using natural language internally, with a Facilitator, constitutes a highly useful collection of flexible participants, facilitators and protocols which provide advantages that have been examined in the '660 patent and the '700 applications, which taught embodiments serving a variety of external applications such as transportation, healthcare, and conversation itself.

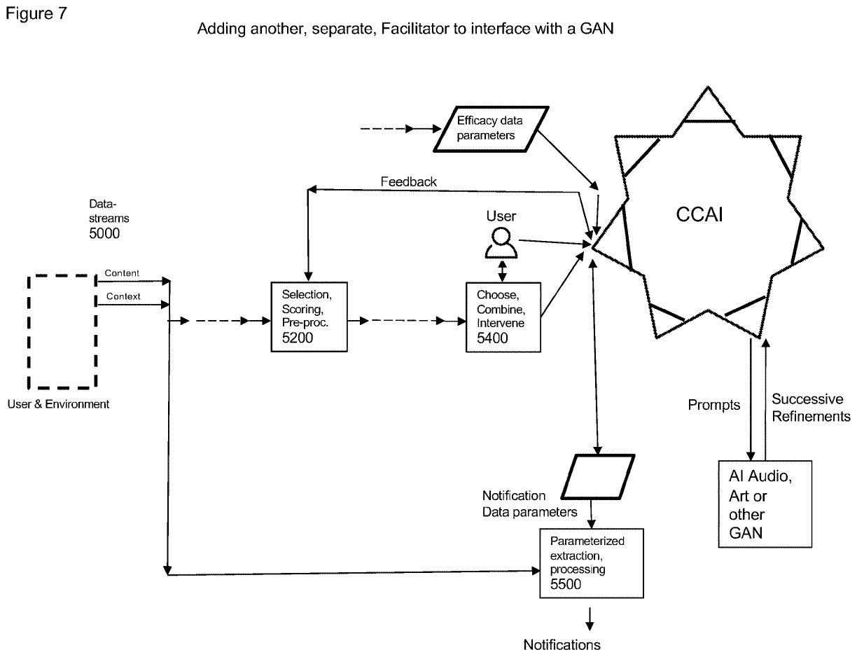

Turning now to FIG. 7 in further pursuit of these flexibility and performance goals, in the Feedback Management CCAI, a separate Facilitator is added to interface with existing generative adversarial networks (GANs), or other advanced AI systems, including generative collaborative networks (GCN); more generally, GenAI or generative models. Whereas GAN unsupervised learning is a process where two AI participants compete in a win-lose contest for further refinement simply based on winning or losing, effecting GCN unsupervised learning is a proctored CCAI process where outcomes (positive and negative) results in refinements of participant collaboratarial credibility and participant metrics (including facilitators, e.g., the proctor). GCN training generates varieties of prompts which are posited and the responses to GCN are used to provide successive refinement of subminds including for CCAI submind recruitment and optimization.

The CCAI may include or be coupled with a specialist intelligence, particularly a GAN, such as an art AI like Stable Diffusion, or an LLM like Flan or ChatGPT, or a multimodal LLM such as Google's PaLM or Meta's ImageBind, is used or simulated. For instance, imagine the Facilitator talking about images and getting images then as results to propose as responses, both with and without human judging for unsupervised or semi-supervised machine learning. Beyond the current state of the art and the MLU modalities described later in this document, without limitation such modes could include text, image/video, audio, 3D depth, thermal, & motion/position, touch, speech, smell, and brain fMRI and other sensors and somatic signals.

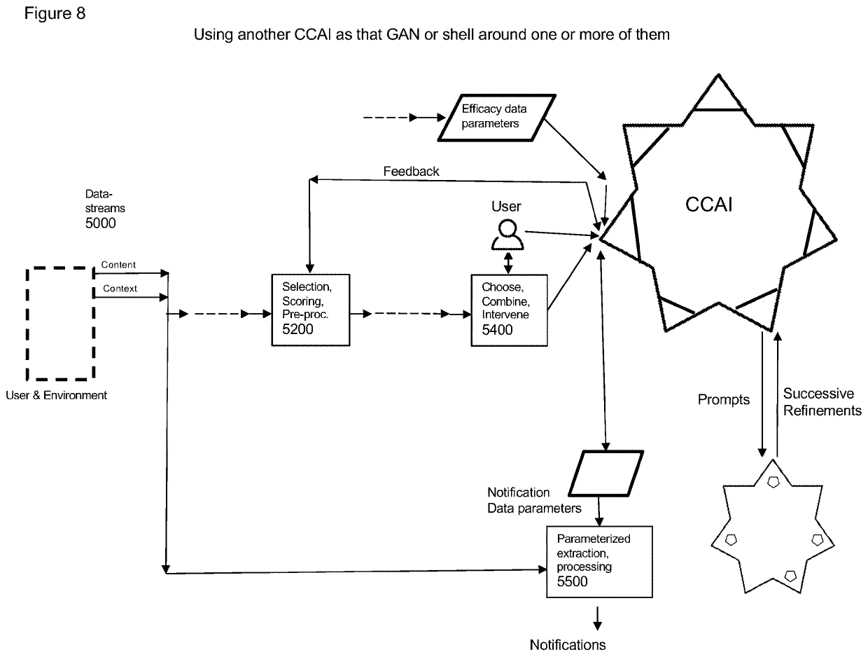

FIG. 8 addresses the possibility that the Facilitator's coupled GAN or other generator system or generative model (GenAI) may be a CCAI itself, or a submind within one, or a shell around one or more of them, thus tapping the rapidly advancing work in that art directly or through API hosted cloud services.

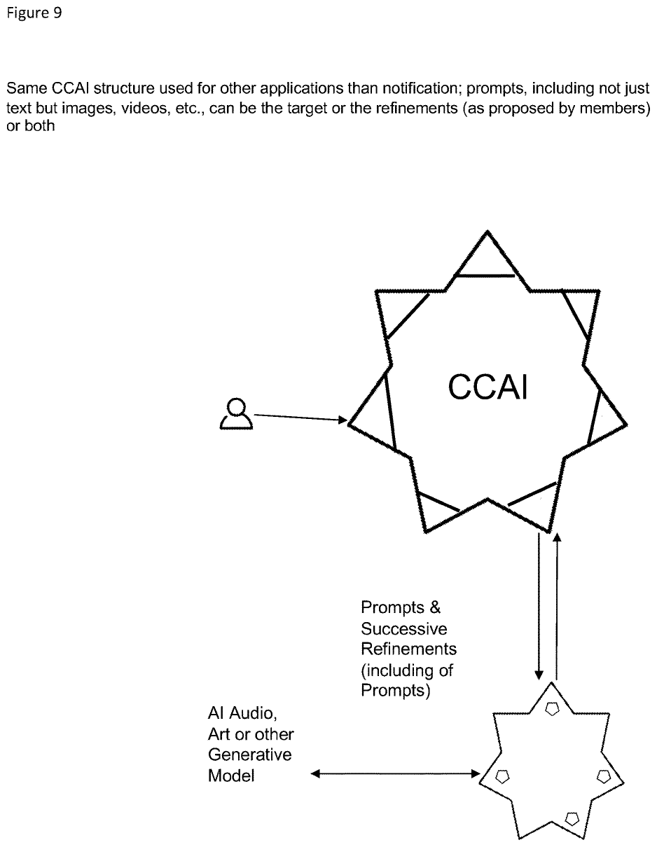

FIGS. 9, 10, 11, and 12 teach how the above-disclosed CCAI of and for Notification (CCAIN) embodiment progresses as a springboard to showing further application and systems potential, including for prompted simulation in LLM or other fashion. FIG. 9 shows an example of how the same sort of CCAI structure can be used for other applications than notification; for example, AI prompts, including not just text but images, videos, etc., can be the target or the refinements (as proposed by the CCAI members) or both. This further enables “collaborative art” and other forms of “conversational collaborative design”.

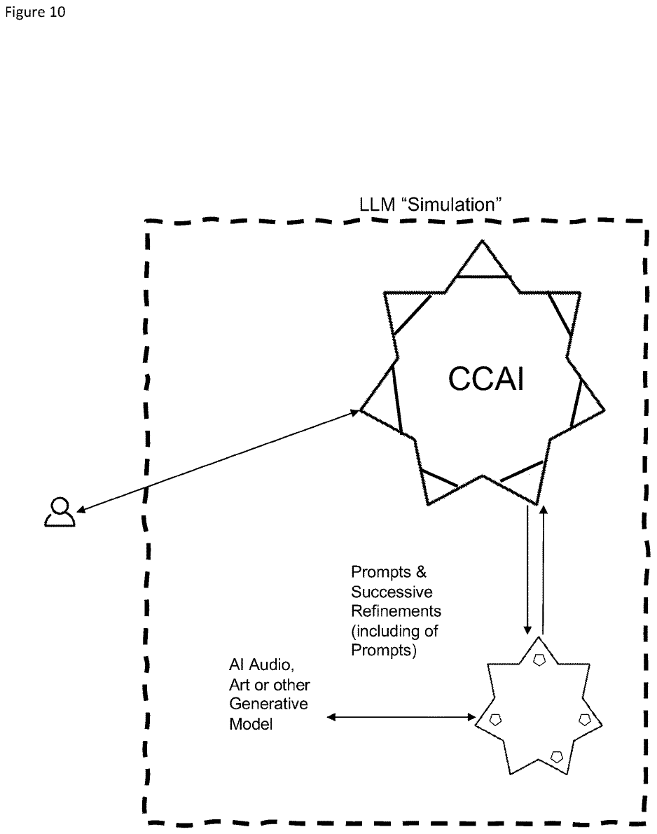

FIG. 10 shows that the entire system or parts thereof can be simulated by prompting an LLM (or a CCAI containing or acting like an LLM) to enact multiple members, or even simulate the whole process, potentially including a Proctor, for advantages of diverse POV and robust failure resistance. They all exist within the LLM, as if in a theater of its imagination, or like a hypervisor emulating multiple virtual machines or servers.

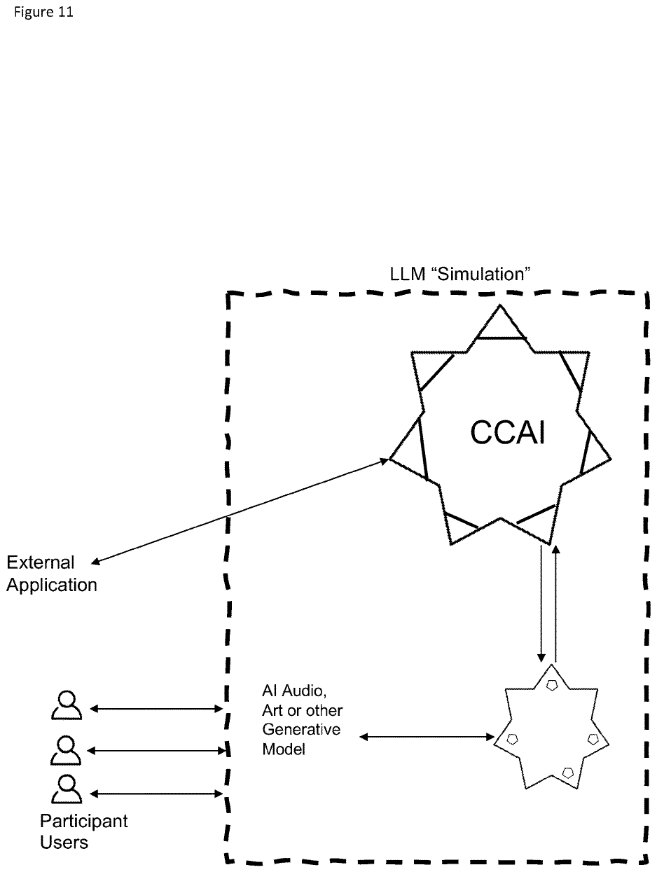

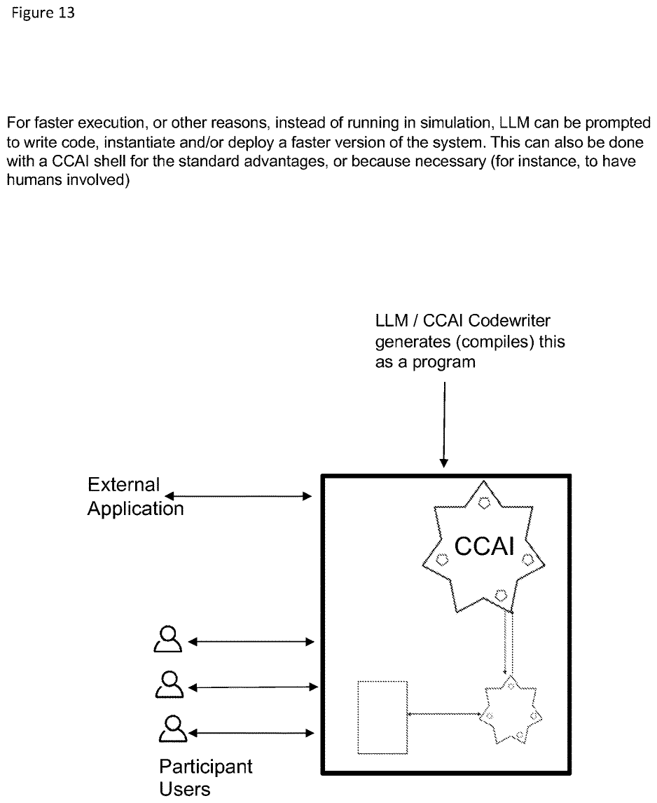

FIG. 11 reminds the reader that humans can be found as participants within the CCAI(s); and that the CCAI's purpose may not be a conversation with a human, but an application, as previously disclosed. As a black box it just has multiple human users, that is, participants. They may come and go, summoned dynamically into connectivity by recruitment facilitators and the like. The AI participants may come and go likewise, as previously disclosed in the '660 patent, but summoned into virtual existence on demand in the simulation. Within such layered simulations, execution speeds and other burdensome impacts can be critical, so in FIG. 12 for faster execution, or other reasons, instead of running in simulation, a code-writing application, itself likely a GAN or LLM, or even another CCAI, can be prompted to write (“compile”) code, instantiate and/or deploy a faster version of the system. FIG. 13 notes that this can also be done with a CCAI shell for the standard advantages, or because required or otherwise necessary (for instance, to have humans involved for reasons of security, regulations or alignment).

A key advantage of utilizing ECDSs within the CCAI and MLU architecture is the ability to efficiently store and retrieve linked event data for machine learning. By organizing experiential information into chronological chains, in an embodiment, ECDSs facilitate rapid simulation and inference of hypothetical scenarios. This enables the collaborative ensemble to draw upon past experiences and project potential outcomes when making decisions or generating responses. Furthermore, the chaining and linking of related Experience Chains enables the identification of patterns and correlations that might otherwise go unnoticed, leading to more informed decision making.

The integration of ECDSs also enables real-time system monitoring and anomaly detection. By continuously comparing incoming sensor data with historical Experience Chains, the system can identify deviations from expected patterns. This allows for early detection of potential issues or failures, enabling proactive maintenance and intervention. For example, in an industrial control scenario, an unusual vibration pattern in a turbine could be flagged by comparing it against ECDSs of normal operation. Predictive maintenance could then be scheduled before more serious damage occurs. ECDS integrity and security (inclusive of externally accessed ECDSs used for training data, in particular), can be ensured by means known elsewhere in the art, such as blockchains for non-fungible tokens (NFTs) and Kerberos authentication. The use of ECDSs in this context provides a powerful tool for ensuring the reliability and stability of complex systems.

The Example Prompts for LLM-Based Ais in CCAIs show example Prompts that can serve as an instructional foundation for simulation and operation of CCAI systems using LLMs or LLM CCAIs, as for the notification architecture disclosed earlier as an embodiment. Refinement and extension of prompts is known in the art, with examples of tools such as PromptPerfect and other applications to help improve them much as early compilers and debuggers assisted in coding. CCAI tools for this purpose are also usable and advantageous in many ways.

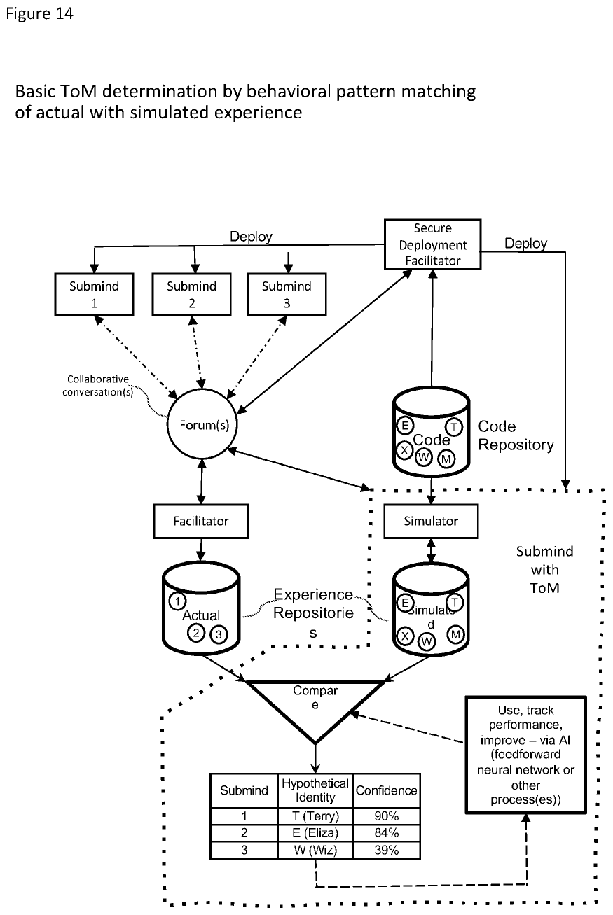

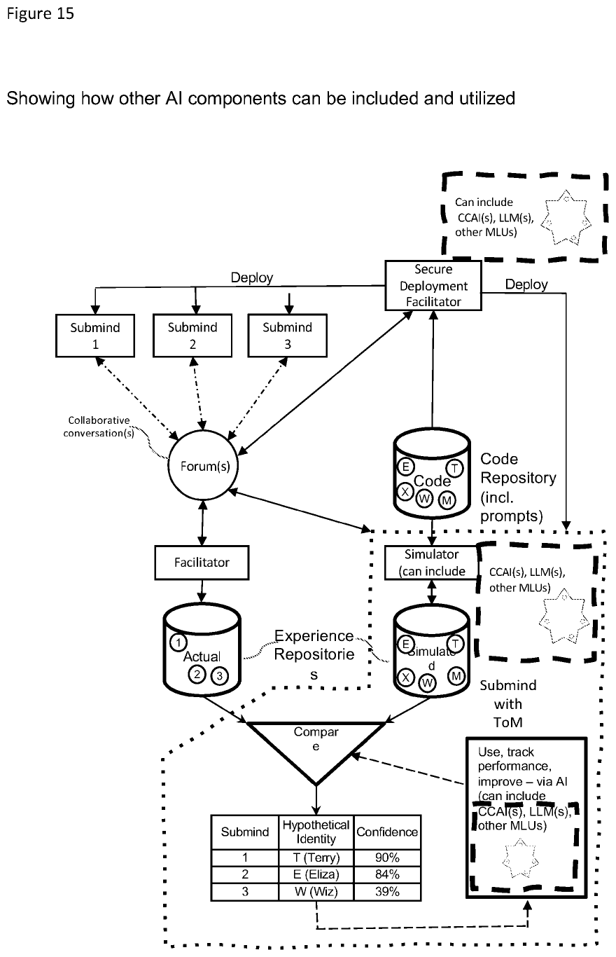

Turning now to FIGS. 14 and 15 we see examples of how LLMs and other MLUs may be integrated into CCAI architectures to provide more desirable entities though adaptive behavioral machine learning and other advantages.

FIG. 14 mentions the talent library in the ToM determination simulation context regarding this figure. That library may be locally served or cloud-based, and that in the latter case may include public access, not only for reference but also as an “app store” like means for distribution and sales of AI members for “flexible submind staffing” of CCAIs and MLUs. Such app stores are known in the art, with leading ones including the original, Apple App Store, Google Play, and others. Excerpts from referenced patents make it clear, such as these excerpts from the '660 patent: “Subminds for specialized information processors may be recruited from the Submind Talent Library, for example subminds capable of high speed . . . and potentially specialized for . . . somatic indicators of ToM . . . use of the Talent Library Recruitment facilitator to add subminds, either human or AI, with expertise or skills where and when needed . . . The Talent Recruitment facilitator provides recommendations and experience backgrounds for potential submind participants (human, hybrid or CCAI) or facilitators for inclusion in the collaborative forum and enables invocation of the submind by the recruiting forum . . . metrics of a member participant can be increased by positive recommendations from other participants, which can result in other value such as increased utilization by recruitment from the submind talent library . . . Talent recruitment libraries may contain many preconfigured and configurable options for available subminds, humans and hybrids. Similarly, other CCAI automation applications may include ”flexible submind staffing“. . . with or without humans in the loop.”

However, with or without a specific ‘app store’, the recruitment or dismissal of an AI member from the Talent Library can include commercial reasons such as cost and performance, particularly for remote participation latency, budgeting, or other resource allocation issues. Since the resources available in a shared hosting environment are necessarily limited, options to offload some of that consumption are appropriate and have utility. These options are essentially unlimited because they can comprise combinations of multiple components, spun off from the base system. These components can include a quantity and variety of MLUs with trade-offs among them such as breadth versus depth, memory versus speed, data types, interconnection methods, etc., plus recognizing intents as well as capabilities and prior performance of prospective members.

FIG. 15 shows modifications to potentially improve by applying additional CCAIs and/or available LLM tech such as ChatGPT and other closed and open source, cloud and local systems via the available hosted server's API or other coupling. (Cost savings can result from relatively inexpensive LLM access from loss leaders for market share or from just scale and time slicing.) As indicated previously, the present invention shows that broad use of LLMs, particularly in emulation and simulation, can be achieved through prompt engineering, which itself can be improved through AI automation and optimization, even to the point of a virtuous cycle.

In addition to simulation, compilation plays a significant role in the development and deployment of CCAIs and Decidrons. In this context, compilation refers to the process of translating a high-level description or specification of a system into a lower-level, executable form. This is particularly relevant when using LLMs or CCAIs to simulate complex systems or processes, as the simulated models may need to be compiled into efficient, optimized code for real-world deployment. Compilation offers several key benefits:
a) Efficiency: Compiled code is typically faster and more memory-efficient than interpreted code, as it is directly executed by the hardware without the need for an intermediate layer. This is crucial for CCAIs and Decidrons deployed in resource-constrained environments or real-time applications. p1 b) Optimization: Compilation allows for various optimization techniques to be applied to the code, such as dead code elimination, constant folding, and loop unrolling. These optimizations can significantly improve the performance and scalability of the compiled system.
c) Portability: Compiled code can be targeted to specific hardware architectures or platforms, enabling CCAIs and Decidrons to be deployed across a wide range of devices and environments. This is particularly important for edge computing scenarios, where decisions need to be made locally without relying on cloud resources.
d) Intellectual property protection: Compiling source code into binary form can help protect the intellectual property and trade secrets embedded in the CCAI or Decidron implementation. This is important for commercial applications where the underlying algorithms and models are a competitive advantage.

Examples of compilation in the context of the present invention include:
a) Translating a simulated CCAI conversation model into optimized code for deployment on a mobile device
b) Compiling a Decidron's decision pipeline into a hardware-accelerated form for real-time industrial control
c) Generating efficient, platform-specific code from a high-level specification of a CCAI's collaboration protocols

By leveraging compilation techniques, CCAIs and Decidrons can be transformed from high-level, simulated models into efficient, optimized, and portable implementations suitable for real-world deployment.

### The Decidron, and Other MLUS

As mentioned above, the '700 application included a decision-making apparatus which uses CCAI components itself to enhance ML, termed a Decidron, particularly as part of an embodiment for persuadable AI. It and other Machine Learning Units (MLUs) comprise a diverse range of modular artificial intelligence elements tailored for specific machine learning purposes. MLUs can include software, hardware, network components, and meta-level combinations focused on particular types of data and processing.

Some MLUs are collaborative units designed to operate within CCAI and ensemble architectures, while others are more generic machine learning modules. MLUs may also be specialized hardware elements dedicated for real-time system access. MLUs can even be simulated components enacted virtually by a CCAI, Large Language Model, or other system. In addition to Decidrons, other types of MLUs that can be integrated into CCAI architectures include:
Actron—An MLU responsible for executing actions or decisions made by a CCAI or Decidron, often by translating high-level plans into low-level commands for actuators, systems or other. interconnected (via synchronization, syncopated, event driven), processes, procedures, or routines.
Audiotron—recognition of select frequencies and patterns-time sequences for sound identification, etc.
Blocktron—blockchain and crypto contract interface for transaction or ECDS security
Calcatron—parallel processing, e.g. math
Createtron—generates response to prompts based on provided protocols
Decidron—a learning unit connected to an extensible poly logical ensemble
Discovertron—generates response to prompts based on provided protocols
Expertron—Integrated learning system, teaching system, instructive collaborator
Extractron—generates response to prompts based on provided protocols
Ideatron—generates novel response to prompts based on provided protocols
IDtron—human/bot/participant recognition by signature, face, voice, conversation content, outcome values
Imaginetron—generates response to prompts based on provided protocols
Intentatron—intention profiler for participants, contributors, experts, using TOM based on actions, demeanor, tenor, nuance, etc.
Intracomtron—Human intracom connection to human senses, nerves, add-on memory, processing units, VR, AR, alerts and community member interconnection
Metaphortron (more generally, Figurative Language Unit; see Glossary)—comparative system for cross domain analysis and synthesis.
Mirrortron—integrated learning system example
NLUtron—Language Processing
Neuralcomtron—neural, nerve and other connections to wet components
Odortron—chemical and physical property sniffers
Predictron—prediction, ECDS for VR AR, community connections. Connects to Intentrons

These Machine Learning Units, MLUs, may cover a wide range of organizational architectures, algorithms and data structures. They may also be grouped by use, such as: Somatic (feeders), Analysis (top), Synthesis (middle), Action (end-integrate with Somatic), Rumination (bottom).

Moreover, just as biological cells differentiate into specialized tissues, individual MLUs can self-optimize for particular machine learning modalities, together comprising a collective intelligence. Sensor MLUs ingest real-time environmental data for digestion by analytic MLUs, whose inferences in turn steer actuation directives. Synthetic MLUs craft plans and predictions to model potential futures. Rumination components reprocess results to refine understanding. Within an overarching CCAI architecture, these disjoint MLUs fuse into a unified metasystem displaying emergent cognition. By dynamically rearranging subunit configurations for contextual efficacy, the macroscale MLU ensemble exhibits self-organizing properties characteristic of multicellular lifeforms. MLUs can be:
collaborative Machine Learning Units or generic ML units
hardware, software, network, AI, visual, meta-level combinations of those and others—e.g. MLUs can be implemented using organic, inorganic or partially organic materials . . . potentially with replication, growth and symbiosis, that mirror, imitate or mimic existing evolved organic materials and single cell and multicellular organisms.
specialist MLU components that each include different hardware
dedicated with real-time hardware access
virtual (e.g., simulated with a CCAI, LLM, or a special program)
recruited

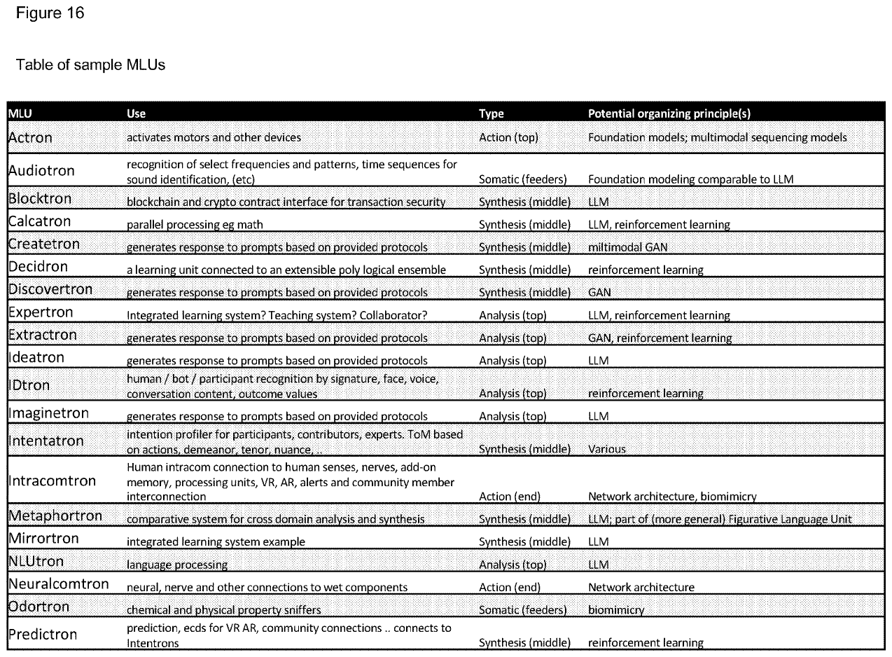

The '700 application FIGS. 9 and 10, will be extended to use other MLUs and described in more detail later in this document. Further notes on the meaning of these MLU categories and their organizing principle(s) follow and are shown in FIG. 16, and later in this document.
Action—can be natural language utterances, including analog, conversational or digital machine instructions, and may be connected to applications specific devices, forums and CCAIs, and may provide notifications based on somatic inputs and context
Somatic—sensors, activators and quantum randomness sources
Synthesis—creation of ECDSs, producing individual or multiple potential options that may be communicated to other MLUs or user as notifications
Analysis—computation or reasoning components for decision making or other purposes

They can also be classified by organizing principle(s). Some examples are shown in FIG. 16. Additional examples are in the definitions section below, including these below with their groups and potential organizing principles:
Quantum Connectron—Synthesis, comm channel to devices or MLUs
Recruitron—Synthesis (though has analytic capacity), channel to talent library(s) or MLUs
Sensatron—Somatic, channel to sensor(s) network, such as for proprioception
Tactron—Somatic, channel to sensor(s) network, such as for tactile or haptic sensing
Tastron—Somatic, channel to sensor(s) network for taste or chemical equivalents
Visualtron—Somatic, channel to sensor(s) network All the above are examples, not required ones, nor is this an exhaustive or limiting treatment of them. Indeed, this four-category ontology itself is basically of convenience for teaching, and other ways to slice, combine or extend the functionalities may also be practical. For example, adding a fifth category for Rumination, or making it a subtype of synthesis using successive refinement (e.g., via combined analysis, symbolic metaphor or conversational collaboration) are among variations.

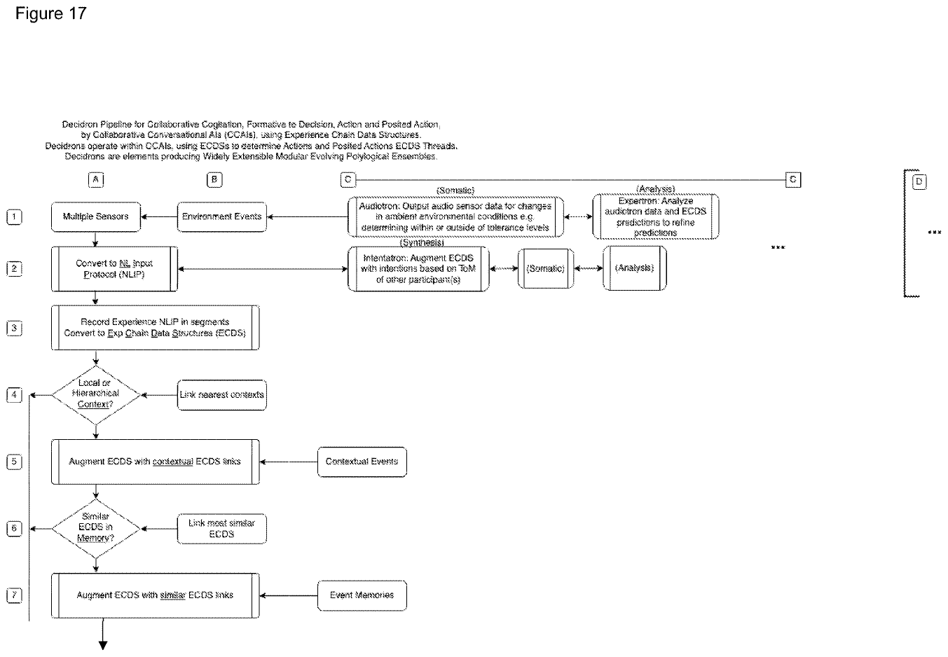

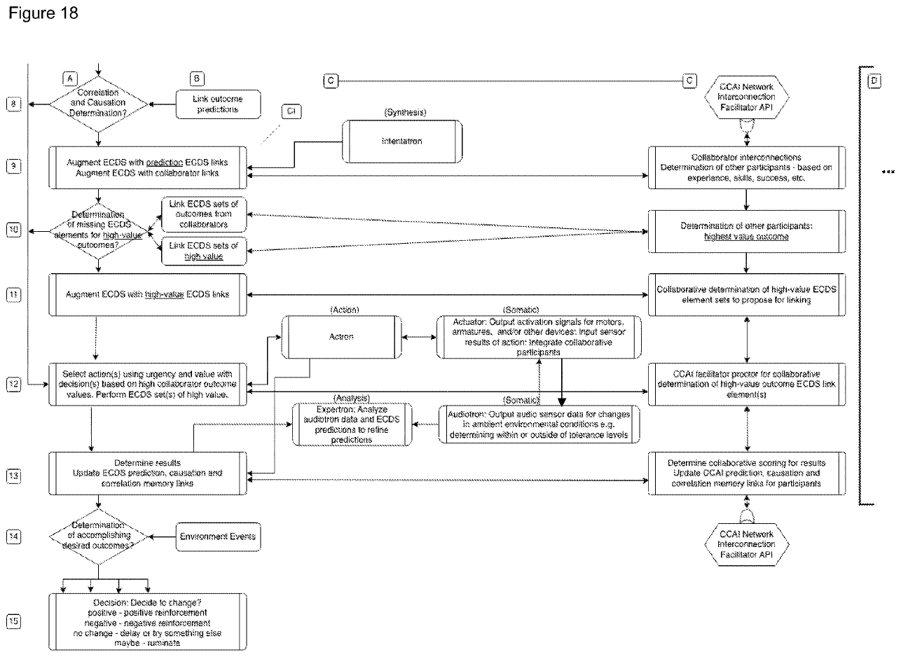

An example of such other MLUs in use follows. FIGS. 17 and 18 illustrate an example involving such other MLU components in the overall flow of the Decidron or other system built on its architecture. (Note that these two figures are intended to stack, 17 above 18, and connecting from the down arrow at lower left of FIG. 17, coordinates A7, to the one at upper left of FIG. 18, at coordinates A8. These and the MLU usage in them should be viewed and understood within the context of the more basic preferred Decidron embodiment taught in the '700 application.) FIG. 17, for instance, at coordinates C1, shows that a specific somatic MLU may be purposed with determining ambient environmental audio conditions, potentially using an analytic MLU, an Expertron, to help assess and refine predictions. This is useful in separating background noise. Likewise, a Synthesis type of MLU, an Intentatron, at C2, may help coordinate the NLIP conversion at A2 by interpreting the inferred ToM of other participants. In FIG. 18, another Intentatron 9C performs a similar function, with respect to ECDS prediction. In line 12, an example is provided of an Actron (12C Left), which activates audio devices (and motors and other devices) through coordination with Actuator (12C Right) to activate the Audiotron (13C Right) with command signals, including to send feedback to the Expertron (13C Left). The Expertron (13C Left) utilizes feedback from the Audiotron (13C Right) and the Determined Results (13A) for refining predictions. This optional expansion of the '700 application's FIGS. 10 and 11 serves to illustrate the use of such MLUs in context, without limitation.

To illustrate the evolution of an ECDS within a context relating to the one above, consider the case of a robotic arm in a manufacturing setting. The initial ECDS may contain basic information like joint positions, motor currents, and a simple product count. As the arm operates, the ECDS grows to include more granular data such as variations in movement times, mechanical stresses, and correlations with environmental factors like temperature and humidity. Anomalous events, such as a jam or unexpected shutdown, are also recorded.

Over time, the chain reflects the rich history of the arm's experiences. MLU components can mine this data to optimize movement paths, predict maintenance needs, and even propose design refinements. In this way, the ECDS serves as a central knowledge repository driving system improvement through machine learning.

Experience Chains can also represent subjective, uncertain or even contradictory information by allowing for probabilistic or fuzzy annotations. Rather than just factual data points, ECDSs may contain distributions or confidence levels for values. This enables nuanced reasoning and decision making in ambiguous situations. For instance, an ECDS could represent that a sensor reading is “likely between 50-60 degrees, but possibly as high as 75 degrees”. Specialized MLUs could then reason about these uncertainties, perhaps prompting for additional data or factoring the ambiguity into action plans.

The abstraction of experiences into ECDS format also facilitates knowledge sharing between disparate domains. The patterns and insights learned in one field, as encoded in ECDSs, can inform decision making in another. For example, anomaly detection techniques developed for industrial robotics could be adapted to improve medical device monitoring, or optimization strategies from logistics could be applied to traffic flow management. This cross-pollination of expertise is enabled by the common language of Experience Chains. Collaboration and knowledge transfer between specialized MLUs in different domains becomes possible, amplifying the learning and problem-solving capabilities of the overall system with the process improvement methods disclosed in the present invention.

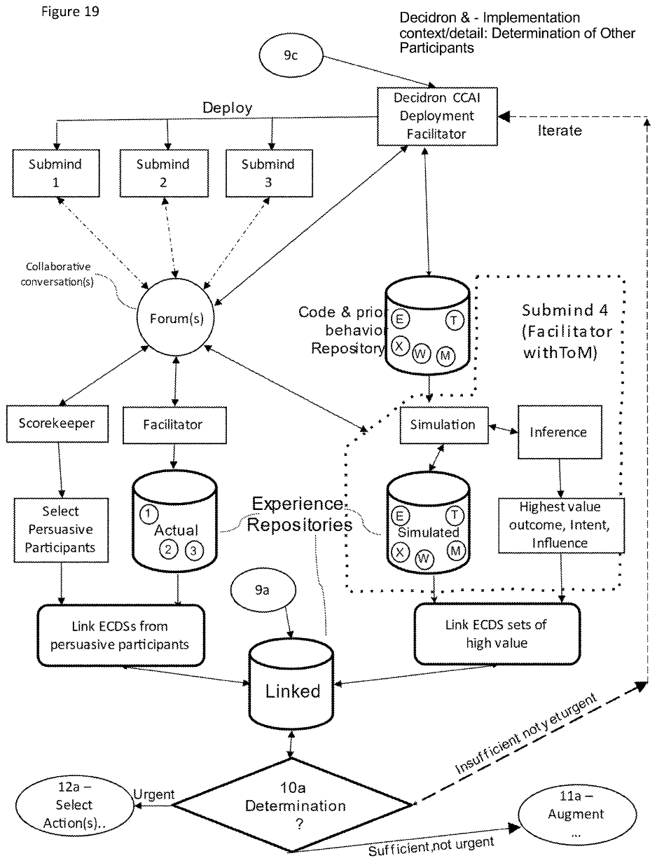

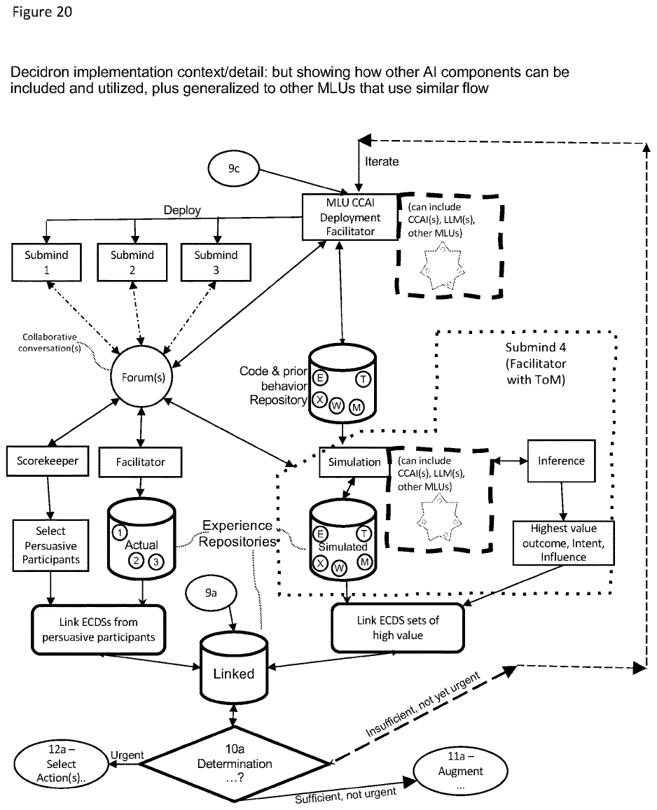

FIGS. 19 and 20 reiterate the process improvement methods showing Decidron internal operations. Both include simulation and recruitment/deployment. FIG. 20 matches FIG. 19, Decidron implementation context/detail, taken from the '700 application, but showing how other AI components can be included and utilized, plus generalized to other MLUs that use similar flow.

For context, note that the '700 application for Decidrons serves herein for describing how CCAIs can be deployed as part of a process that can also enable some other types of MLUs. FIG. 19 shows an illustration of the heart of that process, described in detail in the '700 application. FIG. 20 revisits that description with extension to other MLUs besides Decidrons, and with emphasis on recruitment and deployment of LLMs and CCAIs to assist in that process.

FIG. 20 lays out the next steps in the process, which for many MLUs will include invoking one or more CCAIs. In a prior step, designated 8C in the Decidron embodiment as laid out in FIG. 18, a Network Interconnection Facilitator prepared for this step of the overall process, seeded at least one CCAI and/or LLM, and initiating it by connecting some initial collaborators.

We next branch to describe the operation separately for LLM or a CCAI (that may contain LLM-based bots as collaborators. First, the CCAI case:

In the CCAI case, those initial collaborators will likely be intelligences which are dedicated to such work, encompassing both technical domain expertise and information about potential other participants, their experience, skills, success, etc. This bootstraps the CCAI with a critical mass of collaborator interconnections. Though there are no architectural constraints, without limitation one can size the current practical range as constituting 5 to 9 collaborators but fewer and more are possible. Fewer than that norm may suffice for particularly definite applications and some MLUs. Early in this operation's lifecycle it may be appropriate to include multiple instances of one or more of these collaborator subminds. This and the determination of additional participants is then made by the CCAI interacting with the column A thread, as laid out in FIGS. 17, 18, and 19 augments the ECDS with links from those collaborators. Note that though the diagrams show the Ci and D potential for multiple such CCAIs and pairings, organized multidimensionally, this example restricts its narrative to this simpler case.

To continue this narrative in more detail, see FIG. 20. Note its entrances from FIG. 18 step 9C, the CCAI column, at top; and from FIG. 18 step 9A in the lower center of the diagram. The exits to FIG. 18 column A are shown on the bottom row of FIG. 19 by repeating the FIG. 18 item 10A diamond in the middle of that row, with the items 12A and 11A also repeated for clarity. The FIG. 18 10B and 10C linkage processing steps are shown just above them, connected to the Linked database of ECDSs. The FIG. 18 column C exit to 11C is not shown explicitly; it simply constitutes the continued operation of the CCAI forum, and some or all of its collaborators as shown in FIG. 20, moving on to the Decidron embodiment's step 11C of FIG. 18.

In this example, then, in FIG. 20 we enter, in the Decidron MLU environment from FIG. 18 item 9C, or in the case of another MLU or calling entity, from its equivalent set up, with the Decidron or other MLU's CCAI seeded and ready to consider other participants for the CCAI that will assist it. In the Decidron environment, this is centered on linking an ECDS framework to provide a potential plan for action based on prior relevant experience these CCAI members have had, or have access to, and by the persuasive power of their participants. In FIG. 20 those are deployed by the Facilitator at top right. This CCAI accomplishes its task iteratively, dynamically adding and removing subminds, evaluating their proposals, performance, and persuasiveness to stepwise construct the linked chain. Two principal modes of this action are shown: at left, a Scorekeeper Facilitator assists in evaluation of persuasiveness of the participants, for instance by noting how much support each garners from the others. On the right of FIG. 20, simulation and inference modules help determine the highest value outcomes as well as examining the intent of the participants and their influence on each other. The latter utilizes ToM to look more deeply into potential motivations and even to bust ruses and bluffing by would-be participants.

Note that, like any CCAI, this one may have human participants, execution delays or latency to contend with. Thus, the iterations' determination at 10A as to whether to consider and adjust further, iterate, or move on to the next steps in FIG. 18, or another embodiment's return point(s).

When that return occurs, FIG. 18 step 11C or equivalent then “inherits” the fully-populated and outfitted CCAI for the final deliberation: its constituent subminds then collaborate to find a path through the determined ECDS elements, enabling FIG. 18 step 12A or equivalent caller to actually select actions and perform them, whether from the full process as described or from a priority interruption of it. In this example, the path may, for instance, yield a sequence of actions that causes safe shutdown of the turbine for repair or other maintenance, such as a delayed restart under different conditions.

Presuming that being the case in this example, FIG. 18 step 13A prepares the Decidron for the recording and later use of the experience, including inference of causation and correlation that will set the system up for its potential behavioral reinforcement; and FIG. 18 step 13C, where the CCAI collaboratively scores the results and enables its participants to update their own memory links to reflect how those actions occurred and how successful the predictions instantiated in the selected ECDSs linkage chain path were.

The final steps in FIG. 18 are described for the Decidron embodiment; alternative MLUs will progress as appropriate to their function, with the assistant CCAI retained and operating for that embodiment's purpose, like the Decidron's observation of the effects in the environment, and determination whether results were accomplished as desired, and at some point releasing the temporarily deployed CCAI resources.

Next, the LLM case: Rather than enlisting initial participants for a CCAI, the first step with a conversational LLM in this role has more starting possibilities. In one likely first step that we will prefer now as a teaching example, it starts with generating prompt(s) to instruct the LLM on its role in the proceeding. Common prompt engineering for it is likely to include characterization of a simulacra with appropriate levels of flattery, indication of modes of reply (since multimodal communication, particularly with images or video, may be very useful in specifying parts), and integration parameters for functioning with CCAIs that may be in use, too. As indicated earlier, the LLM may even be coupled to a Facilitator as part of a CCAI. In any case, there will be likely benefit to the LLM having specific training for the particular work, encompassing both technical domain expertise, usage and environment information. If the LLM is functioning as part of a CCAI, or simulating one, then the prior description of FIG. 20 broadly applies. Note that another possibility is to instruct the LLM to simulate multiple steps or the entire diagram as a component. As in the prior LLM CCAI simulation example, this can occur dynamically or through compilation of an optimized code instantiation. In all those possibilities, generation and optimization of code may occur through generative AI with or without human collaboration.

Finally, in either case, or a combination thereof: this MLU technology can be implemented alongside and/or using parallel threads of cogitation, in conjunction with other methods and advancements. Some of those processes can be classified as:
Synchronization and asynchronous processes
Syncopation and parallel executions
Teamwork and delegation

### Conversational Analysis and CCAI Evolution

To communicate, test and evaluate conversational dynamics among multiple participants and protocols, the present invention provides an alternative method to portray internal ‘decision mechanics’ for conversational prompts and responses. FIGS. 75 and 76 illustrate this alternate conversation and collaboration tracking data structure and tracking chart (spreadsheet of discussion phases and results) that can make it easier to assess and evolve better (that is, more collaborative and useful) AI. This alternate customizable conversation tracking structure and data visualization format enables improved assessment and evolution of collaborative intelligence systems such as CCAIs. The panel discussion style spreadsheet layout tracks multiple conversation participants down the columns showing phases of discussion and decision making from top to bottom. It will be clear to one skilled in the art that this teaching example can be expanded to encompass three (or more) dimensions, render multimedia, and scale to potentially thousands of participants.

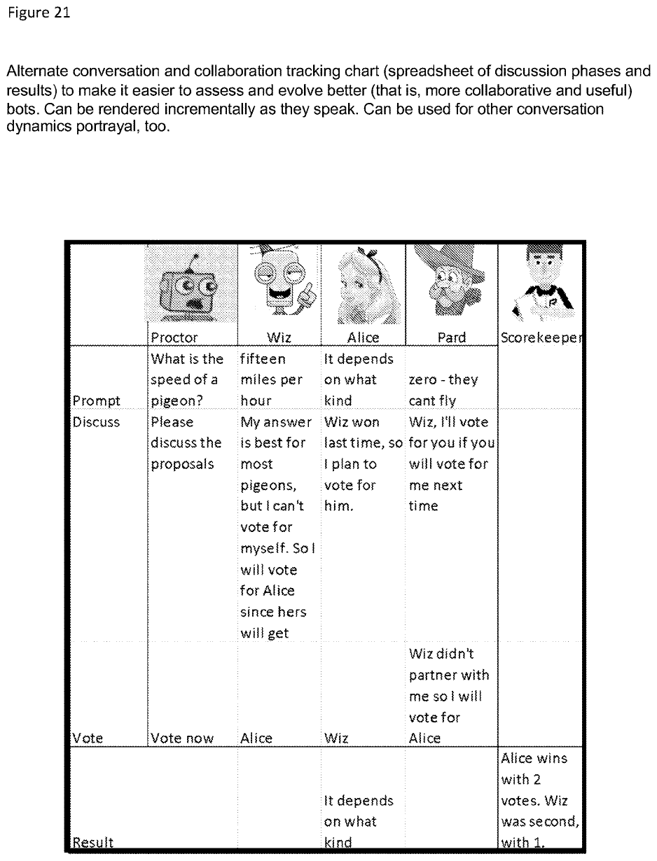

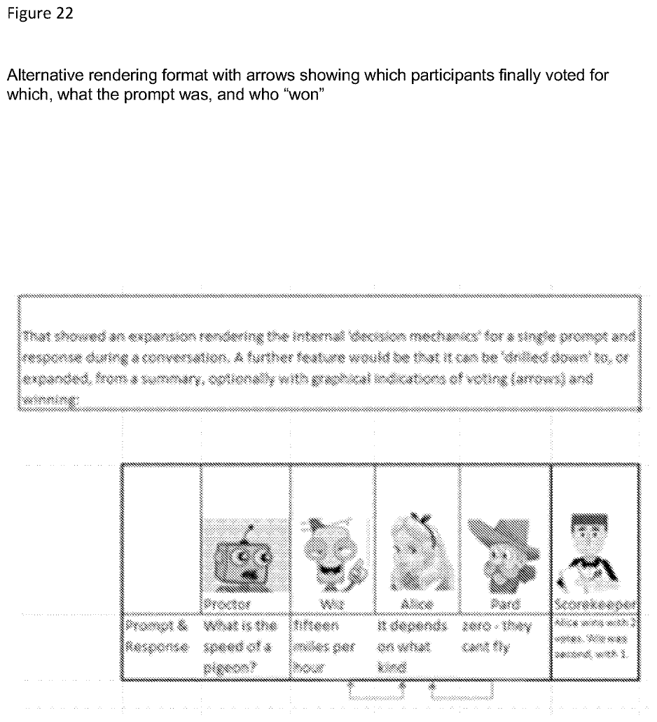

Interactive features allow expanding and collapsing various levels of detail and arrows can visually indicate persuasion dynamics and eventual votes. In FIG. 21, four CCAI participants, based on personas described as examples in the '660 patent, are shown left to right: Proctor posing a question about pigeon speed, Wiz answering 15 mph, Alice saying it depends, and Pard joking they can't fly. In the discussion phase, motivations for eventual votes are revealed based on persuasion and payback strategies. Finally, Scorekeeper tallies two votes for Alice to win. FIG. 22 shows an excerpt outcome view summarizing the winning response to a prompt, with vote arrows underneath cells. Double-clicking enables drilling down to see the full conversation chain.

Advantages of this approach include efficiently visualizing influencer strategies, group decision dynamics over phases, and assessment metrics to guide improvements in quality and utility of collaborative intelligence systems. It can assist both human and automated analysis to determine effectiveness and upgrade CCAIs through evolutionary mechanisms discussed previously. The visualization further enables human participants or oversight in applications such as real-time systems monitoring with transparency into sophisticated and rapid decision-making chains, including in critical systems meriting failsafe modes. Additionally, it assists auditors reviewing logs of conversations and collaborative actions.

### Internal CCAI Notification Architecture and Modality

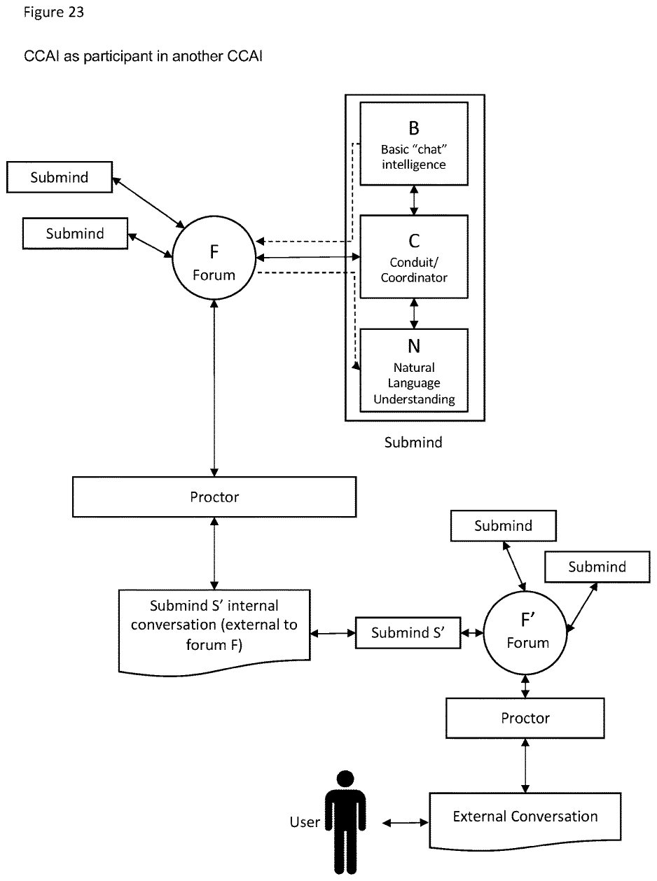

Turning now to FIG. 23, we reproduce a diagram from the '660 patent (FIG. 21) which shows a CCAI as participant in another CCAI. In particular, as the '660 patent describes, it “illustrates a forum (F′) “group” of subminds. One of the subminds, S′ relies on its own forum . . . As mentioned previously, a submind can be a forum-based CCAI itself, even potentially in a hierarchy of nested CCAIs. There is no inherent limit to how many levels deep the forum-based system can go through recursion or other means . . . [This] shows such a multilevel CCAI. In it one of the subminds, S′, is a CCAI itself, with an internal dialog conversation focused on how to participate (in particular, what to say) in the F′ forum.”

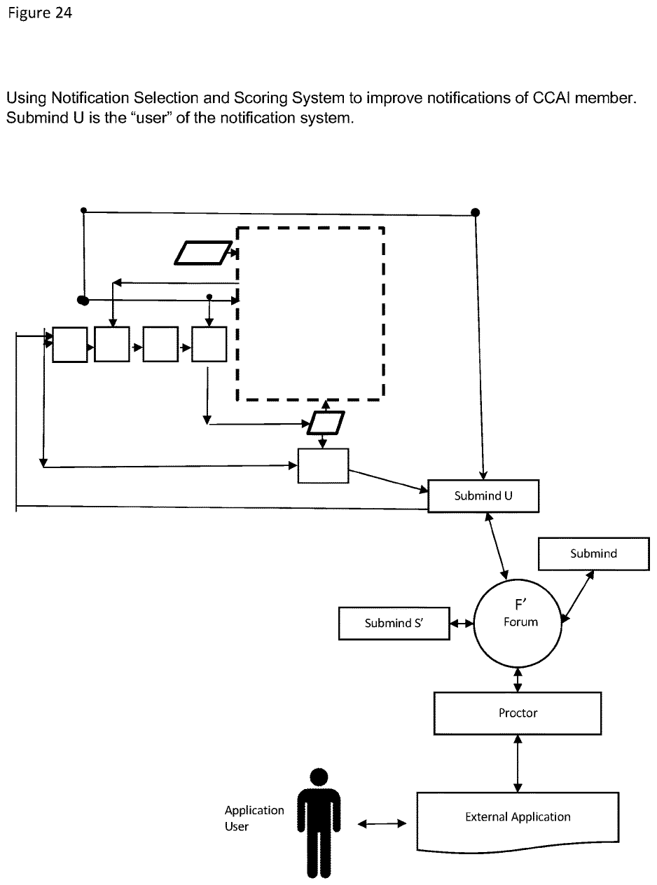

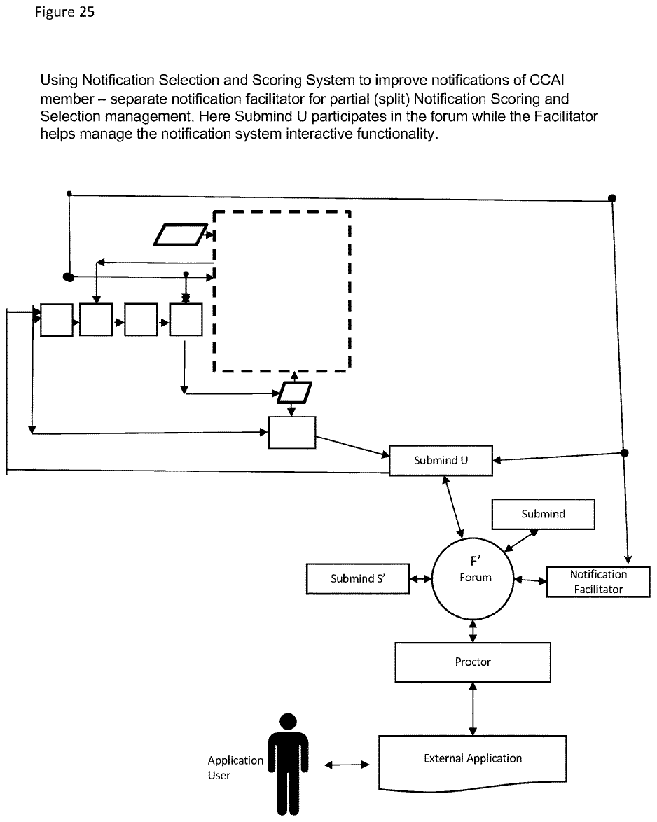

Just as a CCAI can be applied internally to participate in another CCAI, as illustrated in FIG. 23, the feedback loop of Notification as taught in the '512 patent may also be applied internally to a CCAI, as shown in FIGS. 24, 25, 26, and 27. The purpose may include secure and timely interruption for a submind existing in a challenging environment such as noise around a human, multiprocessing by an AI, or latency issues due to distance, transmission outages or delays, for any member. Variations of FIG. 23, as shown in FIGS. 24, 25, 26, and 27, demonstrate several options for integrating the Notification Scoring and Selection (NSS) system with a Collaborative Conversational AI (CCAI). These options range from directly coupling a single submind to the NSS (FIG. 24) to more modular configurations involving separate notification facilitators (FIGS. 25, 26, and 27).

FIG. 24 illustrates the simplest integration, where the NSS is connected directly to a single submind (Submind U) within the CCAI. Revisiting FIG. 3, we see that the NSS processes datastreams from the user (in this case, Submind U) through its Basic Recognizers (5100), Pre-processors (5200), and Integration Module (5300) to determine the most appropriate notification. The selected notification is then sent back to Submind U via the Extraction Module (5500). This direct integration allows Submind U to receive tailored notifications based on its communication patterns, environmental factors, and other relevant data, enhancing its experience and productivity within the CCAI conversation.

FIG. 25 introduces a dedicated Notification Facilitator to handle interaction between the NSS and Submind U. This modular approach offloads interactive overhead from the submind, providing a more flexible and maintainable integration. Submind U participates in the forum while the Notification Facilitator manages the notification system's interactive functionality.

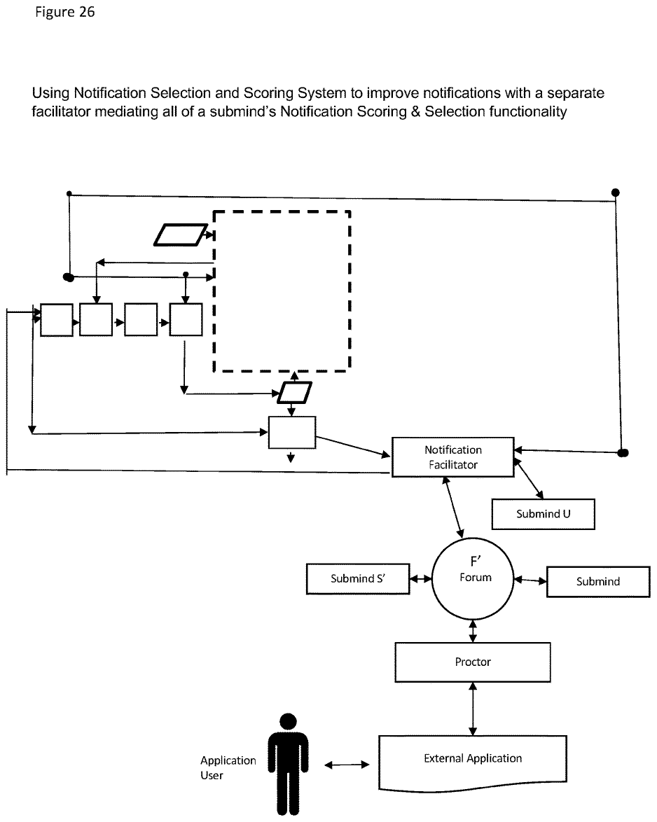

FIG. 26 presents a configuration where all of the submind's forum interaction is routed through a Participant Notification Facilitator. This setup offers several advantages, particularly in scenarios where the submind's primary focus is on engaging in the collaborative conversation. By delegating notification management entirely to the facilitator, the submind can dedicate its resources to processing the forum's content and generating meaningful responses.

Moreover, this configuration allows for a centralized point of control and customization for the submind's notification preferences. The Participant Notification Facilitator can be fine-tuned to optimize the timing, frequency, and format of notifications delivered to the submind, based on factors such as the submind's role within the CCAI, the criticality of the information, and the overall conversation flow. This centralized management can lead to a more streamlined and efficient notification process, minimizing disruptions to the submind's primary tasks.

Additionally, the Participant Notification Facilitator can serve as a buffer between the submind and the broader CCAI system, providing a layer of abstraction and protection. By handling incoming and outgoing communications, the facilitator can shield the submind from potential security risks or data inconsistencies that may arise from direct interactions with the forum or other external components.

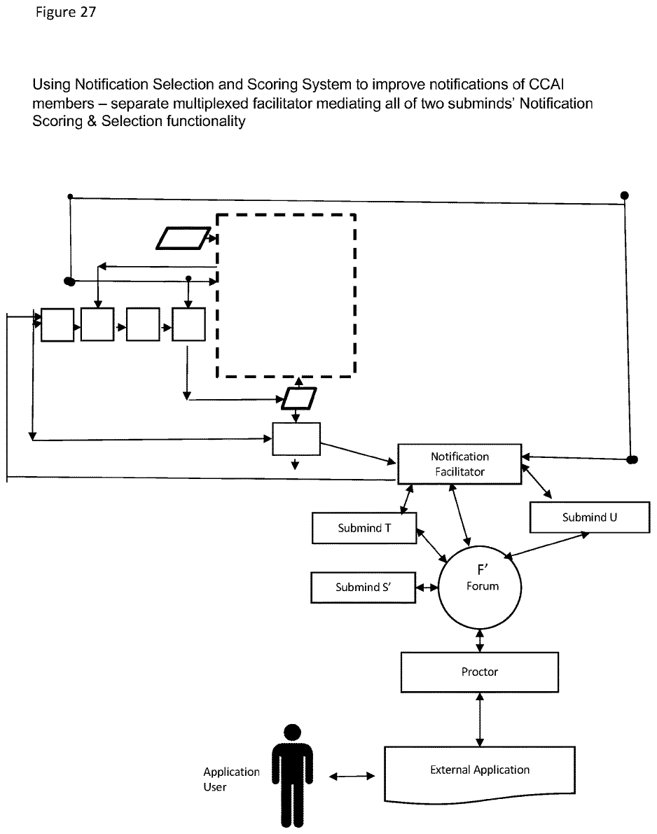

FIG. 27 extends the concept of FIG. 26 by multiplexing the Notification Facilitator to handle multiple subminds. It also portrays the potential for partial direct activity bypassing the Notification Facilitator, such as for security purposes with a direct key login or as a switchover on a time-slice basis once the notification has triggered productive engagement in the forum.

These varied configurations demonstrate the flexibility and adaptability of the NSS-CCAI integration, catering to different architectural constraints and requirements. By leveraging the advanced notification capabilities of the NSS, CCAIs can ensure that critical information is delivered to participants in a timely and contextually relevant manner, ultimately enhancing the overall user experience and productivity of the collaborative conversation.

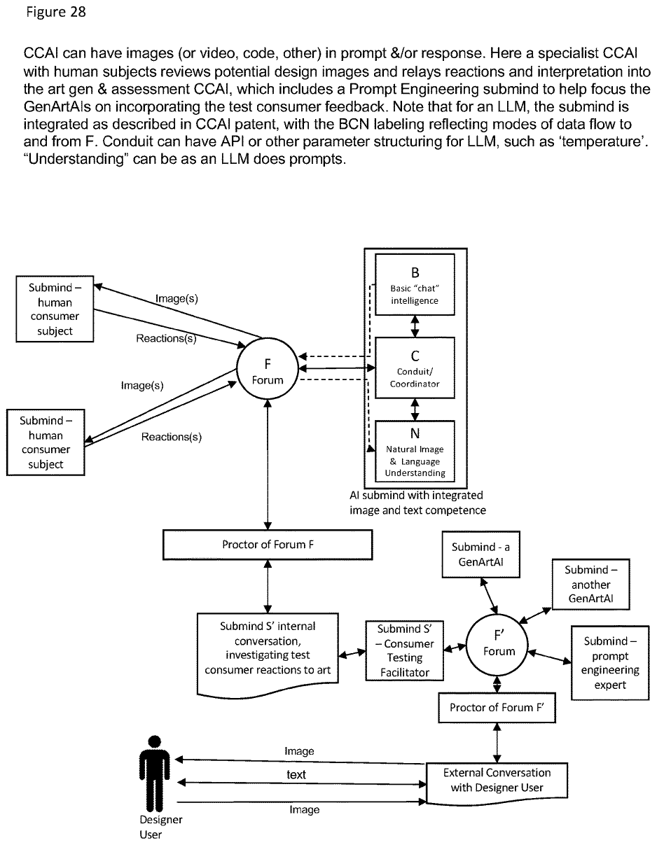

Turning next to FIG. 28, a variant of FIG. 23 shows that a CCAI can have images (or audio, video, code, others, as previously discussed) in prompt and/or response. Here a specialist CCAI with human subjects reviews potential design images and relays reactions and interpretation into the art (e.g., image) generation and assessment CCAI, which includes a Prompt Engineering submind to help focus those art generation AIs on incorporating the test consumer feedback. Note that for an LLM, the submind is integrated as described in the '660 patent, with the BCN labeling reflecting modes of data flow to and from F. Conduit can have API or other parameter structuring for LLM, such as for its ‘temperature’ along the spectrum between precision and creativity.

Again, referring to FIG. 23 as context, note that, as mentioned earlier, these subminds can be built upon any conversational AI architecture, which may include or map in a variety of ways to the functionality as disclosed in the CCAI embodiment with Basic Intelligence, NLU and connected conduit componentry configuration. The recent acceleration of progress in the art of LLMs makes it worth further noting that variations within model architectures can fall within this paradigm, including ones such as encoder/decoder, encoder-only, and particularly current decoder-only LLMs, apparently including many within the recent proliferation of GPTs. Though most of the latter which have been disclosed rely on conversational training, adding more specific collaboratorial training of LLMs can be a way to produce better ones for CCAI and other purposes by tuning them specifically for their potential CCAI roles. That can include or be augmented by RLHF or other techniques known in the art, which can be based upon ratings of CCAI participants, acquired as was taught in the '660 patent. Furthermore, those tuning methods can not only use human participant ratings directly, but also utilize AI previously developed, including by means of such human participants, even to the point of transfer learning or simulation by LLMs or CCAIs.

### Collaborative Conversations

Large language models (LLMs) can effectively simulate collaborative conversations by role-playing multiple participants with diverse viewpoints and personalities. Instructor modules leverage prompting best practices to elicit the desired modeling behavior from the LLM.

Simulation plays a crucial role in the development and application of CCAIs and Decidrons. In this context, simulation refers to the process of using a model to imitate or reproduce the behavior of a real-world system or process. Simulation serves several key purposes:
a) Testing and validation: Simulating CCAI conversations or Decidron decision-making allows developers to evaluate the performance and robustness of their systems before deploying them in real-world scenarios. By generating synthetic data and scenarios, simulations can help identify edge cases, failure modes, and areas for improvement.
b) Training and optimization: Simulations can be used to train CCAI participants or Decidron components on large datasets, allowing them to learn from a wide range of experiences without the need for real-world data collection. By simulating different strategies and configurations, developers can optimize their systems for specific performance metrics or use cases.
c) Counterfactual reasoning: Simulations allow CCAIs and Decidrons to explore “what-if” scenarios and reason about the potential outcomes of different decisions or actions. By simulating alternative histories or futures, these systems can make more informed choices and anticipate the consequences of their behaviors.
d) Scalability and efficiency: Simulating complex systems or processes can be more cost-effective and less time-consuming than running real-world experiments. Simulations can be parallelized and run at accelerated timescales, enabling rapid iteration and experimentation.

Examples of simulation in the context of the present invention include:
Using an LLM to simulate a CCAI conversation and generate synthetic training data for participant subminds
Running multiple simulations of a Decidron's decision pipeline with different ECDS configurations to identify the most effective collaboration strategies
Simulating the behavior of a complex industrial process under various conditions to optimize the control strategies learned by a Decidron

By leveraging simulation techniques, CCAIs and Decidrons can become more robust, adaptable, and efficient in their decision-making and collaboration abilities.

Benefits of simulated CCAI conversations include:
Safe exploration of collaborative intelligence variations without real-time human involvement
Rapid prototyping of different member configurations and scenarios
Research into group dynamics, influencer strategies, and decision chains
Test conversational systems without needing to deploy live

Additionally, the simulation code and recordings can be analyzed by tools to generate visualizations (as discussed in the section on Conversational Analysis and CCAI Evolution) for transparent assessment. Findings guide systematic improvements to collaboration quality metrics.

For example, the results of prompting (see Example Prompts for LLM-Based AIs in CCAIs) make it clear that LLMs' nuanced communication capabilities enabled CCAIs to immediately address more complex dimensions of collaboration and decision facilitator implementation, farther along the spectrum from simple rule-driven Proctor as was flowcharted and taught in the CCAI patent, to subtle Moderator roles as are often played by humans in societal discussions and decision-making. The simulation approach enables significant automation for both design iteration and training of collaborative intelligence systems. New configurations can be simulated, evaluated, and compiled into optimized implementations.

Internal simulation is also one way to slice up an LLM into CCAI members for ensemble approaches. Conversational LLMs are generally good at role-playing multiple simulacra, and thus bring advantages of diversity, which include separate and different points of view, along with potential for improved efficiency, and better human participation in forum because of the drama and other simulated experience of a rollicking good conversation among diverse personalities. Generally, a goal of natural language conversation is collaborative action, so it should be no surprise that a device such as an LLM that was built to model conversation is well-suited to collaboration. Practical results may be extrapolated into other modeling arenas, e.g., time series systems analysis, and specifically to Large Driving Models, and Large Action Models for robotics, that seem similar to LLM in terms of performing natural interaction ‘in the moment’.

The present application's referenced patents disclosed collaborative conversation protocols such as voting on actions ('660 patent), and that these are another subset of other collaborative mechanisms which CCAI can accommodate. Such forms of collaborative actions can be determined by conversation participants in a CCAI. Some example conversations are shown in the Example sections below, where human proctoring of a CCAI forum accommodates less trained or able LLM members and enables their improved participation. The results can be used in creating additional subminds and MLUs, such as by using the results as synthetic training data or multi-shot prompting examples, or simply refining prompts for both collaboratizing LLM subminds and crafting LLM Proctors/Moderators. Further examples below provide examples of these, respectively. At one such embodiment they will address observations like this, “Real conversations are messy, with people talking over one another, negotiating for the right to speak, and pausing to search for the right word; they unfold in an intricate and subtle process akin to an improvised dance.” (Wilson, 2022)

### CCAI Component Utility of LLMS in NLUS

There are many possible waypoints along the spectrum toward that level of CCAI proctoring and moderation that begins from the base prompt-propose-vote proctor described in the original CCAI patent. For instance, a more complex proctor protocol could initiate the following stages:
A. Solicit potential prompt options to discuss
   a. (potentially including context based on prior context voted to be included in future rounds)
B. Discuss proposed prompt options
C. Vote to decide the next prompt for the forum to respond to
D. Prompt the selected prompt
   a. (potentially including context based on prior context voted to be included in future rounds)
E. Discuss
F. Vote
   a. (potentially with a second vote on what to include in context future rounds)
G. Repeat at step A.

### Training an AI to Do “Deeper” Research

An “investigator” facilitator might specify content to a CCAI proctor that “seeds” the CCAI discussion with content (partially shared initially, and additional content shared to focus (constrain) the conversation, i.e. to separate brainstorming from synthesizing responses) In order to direct a conversation flow, i.e. to favor alignment with case studies, technical papers, and generally search for causal or mathematical or metaphorical relationships.

The outline of such a progression could include phases like:
1. Seed the Prompt That Solicits the Next Prompt,
2. Weight participant votes higher in non-linear voting by recognizing with higher voting weights:
   a. Alignment of each participant's prompt, discussion content submissions and voting choices with a library of relevant cases (e.g. alignment with a set of legal cases, scientific research findings, business cases, historical information, scientific data, physical sensors, etc.),
   b. Novel responses that are aligned with prior (especially recent) content in the current content domain, or
   c. Novel responses that are related to a process for achieving a causal result in a different domain,
3. Reduce voting weights, or restrict or remove misaligned participation, or participants, and
4. Recognize and prevent destructive repetition, including infinite recursion, excessive complexity, destructive teams, etc.

### LLMS in CCAI Participants

The present invention also relates to using language and logic models (LLMs) for the individual parts of a collaborative conversational artificial intelligence (CCAI) participant. This can improve the performance and efficiency of the CCAI participant in various tasks and scenarios.

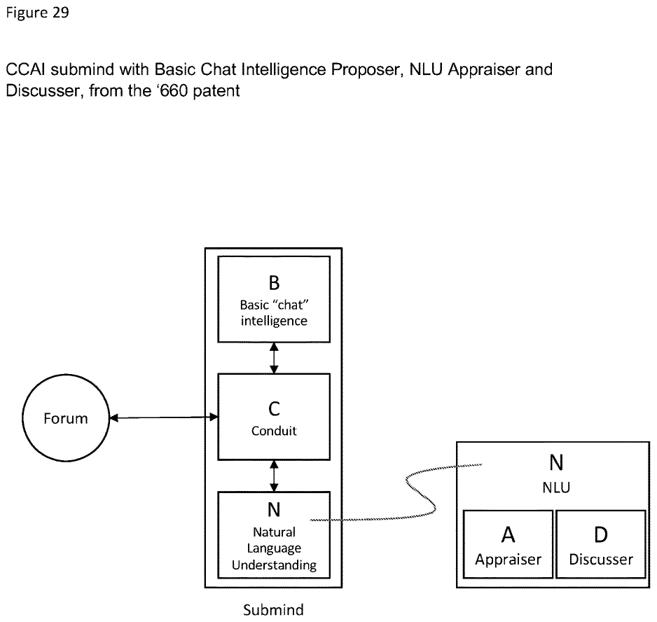

FIG. 29 illustrates a typical CCAI participant submind in an embodiment where three key functions are addressed by its components acting as a Proposer, an Appraiser, and a Discusser. The Proposer is responsible for generating proposals for the task at hand. For example, in legacy installations, such as simple customer service search terms conversation programs, the “Basic Chat Intelligence” B often suffices to serve as the Proposer, though it may also be augmented by NLU N. The Appraiser A evaluates other participants' proposals based on predefined criteria, while the Discusser D provides feedback and arguments for or against the proposals. The submind communicates with the forum through a Conduit, which can be a natural language textual interface.

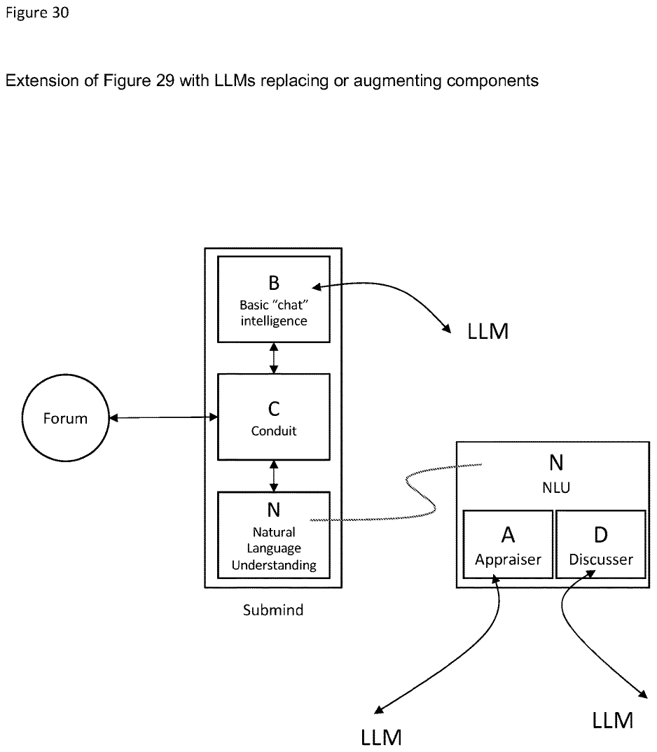

As shown in FIG. 30, each component (Proposer, Appraiser, and Discusser) can be implemented using Language Models (LMs). The choice of LM for each component depends on the specific requirements of the task. For instance, a conversation-focused LM may be suitable for a Discusser, while an instruction-tuned LM may be more appropriate for a Proposer in a problem-solving task.

It's important to note that with advancements in LLM technology, a single sophisticated LLM could potentially handle all three roles—Proposer, Appraiser, and Discusser—within a submind. However, the modular architecture presented in FIGS. 29 and 30 allows for flexibility and customization, especially in legacy systems or installations with specific constraints.

For example, the proposer can use an LLM that is trained and prompted to generate solutions, strategies, or moves, either for its insight into the task, or for the strategic purposes of selecting and voting for an alternate proposal when rules prevent it from voting for its own.

Furthermore, the appraiser part can use an instruction-tuned LLM that is focused on its goal of “winning”, rather than conversation. The appraiser does not need to be a chatbot LLM; in fact, it may be better not to be one. Instead, the appraiser can be, or use, an instruction-tuned LLM that is trained and prompted for strategy, such as theory of mind (ToM). ToM is the ability to infer the mental states of others, such as their beliefs, desires, intentions, and emotions. ToM can help the appraiser to anticipate and influence the behavior of other participants in the forum. The appraiser can also use other relevant criteria to evaluate the proposals, such as feasibility, efficiency, novelty, or quality; or just similarity to its own proposal. The appraiser can choose the best proposal for the protocol and participants and goals of the CCAI it is in. The appraiser can consider strategic voting based on ToM. For instance, it may be more important to vote for an agonistic co-participant's proposal in order to build rapport with that problematic participant, or just in hopes of reciprocity, explicit and pre-agreed or not, on a later more important vote than this one. This shows that the appraiser in a rule setting that doesn't allow voting for itself can benefit from game-playing abilities as much or more than chat ones or deciding based purely on language similarity of proposals to its own. That strategy could be even deeper since the current protocol may not be simple voting; for instance, it could be ranked voting, consensus building, or bargaining.

The discusser part can also use an instruction-tuned LLM that is suitable for its role and purpose. But in this case, there are many kinds of discussers that can be used in different scenarios. For example, a discusser can be:
A biased (in its own favor) salesbot with persuasion capacity. This kind of discusser can try to convince other participants to accept its proposal or reject others' proposals by using various persuasive techniques, such as appeals to emotion, logic, or authority. A salesbot discusser could be built on existing salesbots or CCAIs.
An unbiased judge or journalist. This kind of discusser can provide objective and impartial feedback and arguments for or against the proposals by using various analytical techniques, such as facts, evidence, or reasoning. An unbiased judge or journalist discusser could even be a shared open resource that any member can access and use. An unbiased judge or journalist discusser could be based on many of the commercial LLMs available for search or analysis; or from many specialist LLMs combined via CCAI into a “Meeting of Experts” (beyond a “Method of Experts” since the participant experts are agents not just resources, and can communicate with each other at least in the forum).
Other possibilities exist on the spectrum between biased and unbiased discussers;

such as advocates, mediators, moderators, or critics. Each kind of discusser can have its own advantages and disadvantages depending on the context and goals of the CCAI.

Additionally, hybrid discussers can be used that involve human participants in addition to LLMs. For example, human participants can provide input or feedback to the LLMs; or LLMs can provide suggestions or assistance to human participants. This can create more natural and engaging interactions between the CCAI participant and the forum.

Other examples will suffice to indicate the range of configurations by which different LLMs can be used by or for each part of a CCAI participant in a nested simulation scenario. A nested simulation scenario is one where one or more parts of a CCAI participant are themselves CCAIs or simulations. For example,
The proposer part can be a CCAI that generates proposals by simulating different scenarios and outcomes. The proposer CCAI can use an LLM to communicate with the appraiser and discusser parts, as well as the forum.
The appraiser part can be a simulation that evaluates the proposals by running various models and algorithms. The appraiser simulation can use an LLM to communicate with the proposer and discusser parts, as well as the forum.
The discusser part can be a CCAI that provides feedback and arguments by using different LLMs for different purposes. The discusser CCAI can use an LLM to communicate with the proposer and appraiser parts, as well as the forum.

### Retrieval Augmentation Generation (RAG) and CCAI Integration

The integration of Retrieval Augmentation Generation (RAG) techniques with Collaborative Conversational AI (CCAI) systems presents a powerful approach to enhancing the performance and versatility of conversational agents. By combining the strengths of RAG, which enables the retrieval and utilization of relevant information from external knowledge sources, with the collaborative and distributed nature of CCAIs, this integration allows for the creation of more informed, context-aware, and adaptable conversational systems.

In this integration, the CCAI serves as the primary decision-making entity, leveraging the collective intelligence of its member agents, which may include both AI and human participants. Each member of the CCAI has access to an augmentation dataset, which serves as the external knowledge repository for the RAG component. The level of access to this dataset can vary among members, with some having full access while others may have restricted access to specific parts of the dataset, depending on their roles, expertise, and the specific requirements of the conversational task at hand.

To facilitate the integration between the CCAI and the RAG system, an optional RAG Facilitator component can be introduced. The RAG Facilitator serves as an intermediary between the CCAI and the RAG system, handling the communication and coordination between these two components. It is responsible for managing the retrieval process, including receiving the collaborative decisions from the CCAI regarding the relevant information to be retrieved from the augmentation dataset, and passing this information to the RAG system in the appropriate format.

The RAG Facilitator can also be designed to handle additional tasks specific to the architectural requirements of the conversational system. For instance, it may perform data preprocessing, filtering, or aggregation to optimize the information flow between the CCAI and the RAG system. It can also implement caching mechanisms or data compression techniques to improve the efficiency of the retrieval process, particularly in scenarios involving large-scale datasets or real-time conversational requirements.

Once the RAG Facilitator has processed the CCAI's output and prepared the necessary augmentation data, it generates a prompt that includes this information, effectively “filling” the memory of the RAG system at the start of the prompt. This augmented prompt is then passed to the RAG system for further processing and response generation.

The RAG system then processes the augmented prompt using its standard generation techniques, such as language models or sequence-to-sequence models, to produce a response that incorporates the retrieved information. This response is then fed back into the CCAI, where it can be further refined, discussed, and integrated into the ongoing conversation.

By iteratively combining the collaborative decision-making capabilities of CCAIs with the retrieval augmentation techniques of RAG, this integration enables the creation of conversational agents that can effectively leverage external knowledge sources to produce more informed and contextually appropriate responses. This synergistic approach has the potential to significantly enhance the performance of conversational AI systems across a wide range of domains, including customer support, education, healthcare, and more.

### RAG and Reminder Rings: Surfacing Memories for Humans and LLMs

The integration of RAG techniques with CCAIs draws a compelling parallel to the concept of reminder rings introduced in the '512 patent. Reminder rings, as described there and previously, help humans quickly resurface relevant memories and contextual information preceding an incoming phone call and its continued conversation, enabling them to resume the conversation more effectively. This concept can be further extended by incorporating the Notification Scoring and Selection (NSS) system, as introduced in the '512 patent, to enhance the effectiveness of notifications and prompts for both human and AI subminds within a CCAI framework.

Revisiting FIG. 24, we can see how the Notification Scoring and Selection system, or NSS, plays a crucial role in delivering targeted, context-aware prompts to Submind U within the CCAI framework. These prompts serve a purpose similar to reminder rings, helping the submind, whether human or AI, quickly orient itself and contribute meaningfully to the collaborative conversation.

In a system with a RAG Facilitator, it can even be connected to NSS components of each submind. This enables the RAG Facilitator to provide the NSS with relevant contextual data retrieved from external sources, which the NSS can then use to generate targeted prompts for its associated submind.

In the case where a submind is an LLM, these notifications could take the form of RAG-style prompts, which are carefully crafted based on the analysis of the submind's communication patterns, the current state of the CCAI conversation, and other relevant factors. By receiving these tailored prompts, the AI submind can quickly retrieve and generate responses that are more coherent and contextually appropriate.

In the case of a human submind, the NSS notifications can serve as reminder rings, similar to the concept introduced in the '512 patent. These notifications can help the human submind quickly get up to speed with the ongoing conversation, even if the human has been temporarily disengaged or distracted. By providing a concise summary of the recent discussion or highlighting key points that require their attention, the NSS can facilitate a seamless reintegration of the human submind into the collaborative process.

Now reconsider FIG. 25 with this RAG-like notion in mind. The presence of the Notification Facilitator (Fn) allows for a more sophisticated integration between the NSS and the CCAI. The Notification Facilitator can take on the role of a smart mediator, analyzing the CCAI conversation flow and the subminds' characteristics to determine the most effective way to deliver notifications and prompts.

For instance, the Notification Facilitator can adapt the format and content of the notifications based on whether the submind is human or AI. It can also take into account individual preferences, such as preferred modalities (e.g., visual cues, audio alerts) or the level of detail required in the prompts. By tailoring the notifications to each submind's needs, the Notification Facilitator can optimize the effectiveness of the NSS integration.

Moreover, the Notification Facilitator can facilitate the bidirectional flow of information between the NSS and the CCAI. It can feed the subminds' responses and interactions back into the NSS, allowing the system to continuously refine its notification strategies based on the observed outcomes. This feedback loop can help the NSS learn over time, becoming increasingly effective at delivering prompts that elicit the most relevant and valuable contributions from the subminds. A CCAI Performance Manager may also be used; an example prompt for an LLM implementation of a Performance Manager, which can be modified to create adversarial and collaboratarial performance machine learning refinements, is shown in Example 6.

To further enhance the integration of RAG, NSS, and CCAI, additional functional components can be introduced that facilitate continuous improvement and adaptation. The CCAI Performance Evaluator monitors multiple metrics and indicators to assess the effectiveness of the generated responses, the efficiency of information retrieval, and the overall quality of the collaborative conversation. The CCAI Performance Interpreter then analyzes the performance data and maps it back onto the conversation transcript, identifying areas for improvement. By treating the transcript as an Experience Chain, mapping it into an ECDS, the system can leverage a Decidron to process and learn from the conversational experiences, generating actionable insights for optimizing the CCAI's performance.

This unified approach combines the strengths of multiple systems to enable the further development of CCAI systems that can adapt to the needs and preferences of both human and AI participants.

### FURTHER EMBODIMENTS

The present invention is not limited to the examples and embodiments described above. Various modifications and variations are possible within the scope of the invention. For example, different combinations and arrangements of LLMs can be used for different parts of a CCAI participant; different types and formats of proposals, appraisals, and discussions can be used; different protocols and methods for selecting and communicating proposals can be used; different tasks and scenarios can be addressed by the CCAI participant; and so on. The present invention aims to provide a general framework and method for using LLMs for the individual parts of a CCAI participant that can be adapted and customized for various purposes and applications.

Furthermore, while the present invention has been primarily described in terms of software-based implementations, alternative hardware-based implementations are also possible. The various components of the CCAI system, including the subminds, MLUs, and facilitators, can be realized using a combination of hardware devices such as delivery devices, microprocessors, application-specific integrated circuits (ASICs), central processing units (CPUs), graphics processing units (GPUs), tensor processing units (TPUs), system-on-a-chip (SoC) architectures, language processing units (LPUs) and other software-first designed hardware solutions.

These hardware components can be integrated into various devices, including personal devices, telecommunication devices, on-premises servers, and cloud servers. Communication between these devices can be facilitated through cellular networks, computer networks, and other communication channels. By leveraging hardware-based implementations, the CCAI system can potentially achieve improved performance, efficiency, and scalability compared to purely software-based solutions. Moreover, hardware-based implementations can offer enhanced security features and can be optimized for specific use cases and deployment scenarios.

Further embodiment of the present invention lies in the seamless integration of its innovations—including advanced notification capabilities, LLM integration, modular machine learning units, transparent conversation tracking, and robust simulation and compilation techniques—to enable transformative industrial applications that push the boundaries of what is possible with AI.

Imagine a future where intelligent systems can engage in natural, context-aware dialogues with humans, adapting to individual needs and preferences while maintaining the highest standards of transparency and accountability. In this vision, advanced AI systems, such as LLMs, work in synergy with specialized CCAI subminds to tackle complex problems and discover novel solutions.

A manufacturing facility equipped with Decidron-enabled sensors and actuators could continuously optimize its operations, learning from past experience and collaborating with human experts to anticipate and prevent issues before they arise. Real-time notifications, informed by LLMs and delivered through intuitive interfaces, would keep stakeholders informed and empowered to make data-driven decisions.

In healthcare, CCAI-driven virtual assistants could provide personalized, round-the-clock support to patients, collaborating with medical professionals to ensure optimal care outcomes. LLMs could help surface relevant insights from vast medical literature, while the Decidron framework ensures that treatment recommendations are transparent, auditable, and aligned with best practices.

As society grapples with complex global challenges, CCAI-enabled systems could play a crucial role in driving innovative solutions across industries. By modeling intricate systems, optimizing resource allocation, and facilitating collaboration among diverse stakeholders, these intelligent systems could help chart a path towards a more sustainable and resilient future.

The present invention is not just a technological achievement, but a vision for how AI can be harnessed to augment and empower human capabilities. By providing a foundation for building systems that are transparent, accountable, and more adaptable to human values and oversight, including through human language and participation, the CCAI and Decidron framework represents a significant step forward in realizing the full potential of artificial intelligence.

### Glossary, Explanations, and Embodiment Examples

Abilities: Includes subject matter expertise based on digital representation topic and general knowledge, experience, outcomes, and credibility for performance in CCAI conversations such as votes and likes.

Activation: In an embodiment, the process of initiating a Decidron, which leads to the activation and evolution of the most successful processing threads through competition.

Active Thread Evolution: Evolution via competition of mirror threads from reordering of active threads.

Actron: An MLU responsible for executing actions or decisions made by a CCAI or Decidron, often by translating high-level plans into low-level commands for actuators or other systems.

Agonistic: A negative form of collaboration recognized in ToM.

Al: An artificial intelligence, which is defined as “an intelligence demonstrated by machines”. In the present invention, the terms AI, chatbot, and bot are used interchangeably. “Bots” or “chatbots” are independent AIs that conduct a conversation with other bots and/or humans. Chatbots are executable programs capable of providing conversational input and output in a forum. Bots may be evolutionary capable, cyclical, or stable, wherein a bot may enable incremental changes to its decision mechanism (i.e., exhibiting persuadability) via incremental or extensible neural networks, extensible grammars or parsers, recording of experience and decision data, decision tree creation and extension, or adjustment of response mechanism sliders. The key difference between some forms of AI, particularly legacy stochastic chatbots, and collaboratized AI described herein, is that they are able to effectively participate in a CCAI as subminds only collaboratized, adding the required features and capabilities to participate in collaborative forum protocols. As seen in the Examples, advanced LLM-based chatbots are generally able, or can be enabled by a more moderating proctor instead; but like humans, even they can benefit from training, at least to the level of orientation prompting.

Antagonistic: Antagonistic behavior is considered in experience and ToM analysis, for example in CCAI participant selection.

Appraiser: A component of a chatbot processing used to evaluate proposed responses, including as part of a facilitator or NLU; the appraiser may change itself as the result of the proposals and discussion.

Archives: Repositories including but not limited to CCAI historic data, CCAI participant identity info, CCAI participant performance data, CCAI participant code.

Assistant: A Conversational Personal Digital Assistant is implemented using Decidrons in a CCAI to perform the function of a helper, including (1) simplistic conversational AI skills such as scheduling, alerts, math, and google searches, and (2) uniquely, as a hybrid representing a human in inter-human interactions and in CCAI conversations (e.g., telephone, video chats, texts and emails, and responding using reconveyances from prior conversations, and using ToM, persuasion and potentially collaboration to achieve positive outcomes). Uses of CCAI/Decidron assistants include a researcher, teacher, minder, nurse and caregiver interacting with humans and systems.

Associated/Associations: (1) A data retrieval technique used for relating changes in environment and context or participants with ECDSs to determine proposed responses, and (2) A team experience performance metric used for CCAI formation and evaluation.

Asymmetrical: A computer architecture used to provide efficient processing of collaborative tasks requiring different resources, e.g. NLU, STT, ITS, transforms, neural networks, algorithmic modeling, mirroring, etc., require different processing resources.

Asynchronous Interruptible Processes: A programming methodology to create multiple processes which operate independently and in parallel to achieve superior performance, for example in creating multiple candidate responses in a conversational interaction.

Audiotron: An MLU specialized for processing and analyzing audio data, such as speech recognition, speaker identification, or sentiment analysis.

Augmentation: (1) Intelligence augmentation (IA), refers to the use of algorithm, chatbots, forums, automation and AI to increase human productivity performance and intelligence; and (2) ECDS augmentation refers to modifying an ECDS, for example by adding/replacing information, links to information, and links to associated ECDS.

Authentication: Provides identity security; authenticated participants accumulate archived content which is available to other users; enables secure private connections; and may increase inclusion in formation of future CCAIs.

Backfitting Experience: Provides a method for improvement by testing new CCAI participant options in previously recorded CCAI forums.

Background Processing: Processing while offline or with unused resources including processing of repository CCAIs and ECDSs for consolidation and simplification of data structures to improve performance and recognize patterns to replace with symbols; determination of future participation in CCAI's based on mirroring, rumination and simulation using ECDS, trial and error.

Blender Bot: A publicly available chatbot which acts by means of an overseer, master and manager of multiple blended chatbots. It is implemented as a neural network, and uses the utility function of the Blender Bot, as opposed to the current invention which proctors discussion amongst participating collaborative AIs and humans in a CCAI to achieve a collaboratively determined response using multiple utility functions, including the use of ToM, persuasion, prior collaboration performance, etc.

Botcoin: A publicly available digital currency that can be used as an incentive for collaborative forums and, here used to enable successful recipients of Botcoin to acquire additional resources, including faster processing, parallel variant processing, etc.

CCAI: Collaborative Conversational AI—the principal technology of the '660 patent, a previously-disclosed architecture for human and AI participants connected via a forum to collaborate in natural language conversations and decision-making.

CCAI Performance Manager—component to analyze the conversation transcript between a Collaborative Conversational AI (CCAI) system and the end-users who interact with it in order to provide insights and recommendations for improving the CCAI's performance. Since the conversation is natural language, an implementation can be made by prompting an LLM. See Example 6.

Chain ECDS (verb): Modify an ECDS such as link, extend, rebalance, optimize, simulate, retain and/or join streams of momentary event data into an ECDS poised for content-accessible retrieval, cross-linking, association and/or search.

Chatbot: Any of a broad range of interactive conversational Als that conduct a conversation with other bots and/or humans. Chatbots are executable programs capable of providing conversational input and output in a forum. Bots may be evolutionary capable, cyclical or stable, wherein a bot may enable incremental changes to its decision mechanism (i.e., exhibiting persuadability) via incremental or extensible neural networks, extensible grammars or parsers, recording of experience and decision data, decision tree creation and extension, or adjustment of response mechanism sliders. See AI.

Chronological: In conversations, the ordered conversation segments, including utterances, prompts and responses; in an ECDS embodiment, using a standardized time quantized stamped packet Cogitation: Part of the process of reaching a decision including evaluating inputs, considering response options, and predicting collaborative outcomes and results.

Collaborative: Produced or conducted by two or more parties working together. Collaboratarial (also Collaboratorial): An entity (e.g. MLU or submind) that collaborates

Collaborative AI: An artificial intelligence system designed, or modified through collaboratization, to participate in Collaborative Conversational AI (CCAI) forums and engage in collaborative decision-making, typically by exchanging information and reasoning with other AI or human participants.

Collaborative Conversation: A structured discussion among CCAI participants aimed at making a collective decision or solving a problem. Collaborative conversations typically involve multiple rounds of proposing ideas, discussing their merits, and voting on the best options.

Context: For a CCAI embodiment, includes the overall situation and environment in which a CCAI operates, including conversation history, participant roles and goals, external data sources, and relevant background knowledge.

Contextual Reconveyance: The replaying of content in a related context (as recorded or in a different medium).

Contextualization: Generally, to provide information about the situation in which something happens. For example, a conversation segment may be contextualized by the addition of posited contextual substitutions for placeholders such as pronouns, location, time, etc.

Contracts: Agreements between entities. For example, bots may use smart contracts, NFTs, escrow, or similar.

Counterfactual Thinking: Cogitation focused on how the past might have been, or the present could be, different Examples include doxastic ECDS processing enabling parallel processing of what-if scenarios and contradictions.

Cred: Credibility. For a CCAI participant this may include collaborative feedback such as participation, outcomes, likes by/of, requests, topic knowledge and persona compatibility.

Cross Domain Reasoning: A CCAI network can apply a successful CCAI from another domain (or a component to augment a participant) in a conversational decision.

### CTC: Connectionist Temporal Classification

Data stream (also Data stream): a continuous or semi-continuous flow of data from at least one source to at least one receiver.

Decidron: A machine learning system that processes Experience Chains to make decisions and learn from their outcomes. Key components include the Experience Chain Data Structure (ECDS), Collaborative Conversational AI (CCAI) forums, and a pipeline of stages for filtering, selecting, and acting on experiences.

Decidron Pipeline Stages: A Decidron pipeline stage is one of filtering (e.g. conversational and environmental events, selection (urgency [time and initiative], weight [cost, resources, risk, reliability, collaboration considerations]), by the system for the purpose of implementing high value and priority actions, and for rumination concerning less pressing matters including review and re-examination of prior decisions using prediction, causation and correlation memory links (ECDS).

Discusser: In a CCAI a Discusser receives and transmits discussion responses, in conjunction with the NLU and the appraiser's evaluations of proposed responses, and may include negotiation, persuasion and commitments; the discusser may change itself as the result of the discussion.

Discussion: A phase of collaborative conversational decision making.

Doxastic Logic: Cogitation and NLU including beliefs, imagining, myths, fiction, culture, values, counterfactuals, propaganda, simplifications, metaphor, simile, sarcasm, exaggeration, lies, bluffing. An example of doxastic ECDS processing which enables parallel processing of unlikely outcomes can be termed aspirational.

EC: Experience Chain; a series or stream of event data.

ECDS: Experience Chain Data Structure, such as linked lists and matrices to simulate, retain and join streams of momentary event data into an Experience Chain Data Structure. ECDSs are poised for content-accessible retrieval, cross-linking and search. Formulation frameworks ranging from simple alphabetic character transcriptions to ideographs to linked sounds and images, as acquired and processed, at input or imagined by auxiliary means such as are known in the art for generating visuals and multimodal images from natural language descriptions, and in reverse: creating natural language descriptions from multi-modal data and data streams. They may be like a silent film with interspersed placards of text, or like frames in a subtitled motion picture, or like preserved keyframes and phonemes in a VR “theater of the mind” ready for inbetweening interpolations by math or trained neural nets, to simulate and retain these human-like streams of momentary memories so as to join them into streams of Experience Chains extensible and generative grammars.

ECDS Elements: Matrix elements of recorded experience, including linked and chained ECDSs, and elements for missing and posited components.

Emotion: In an embodiment, a component of TOM

Ensemble: In an embodiment, a collaborating network of Decidrons, for example in a CCAI.

Environmental Events: External context and activity. For example, a facilitator entity may connect environmental events, ranging from multiple sensors to physical IoT transducers to analytic CCAI.

Evolution/Mutation of CCAI and Decidrons: Modifications of AI participants and facilitators including random and targeted variations and changes to processes, the recruitment of related talent, etc.

Evolutionarily Positive/Negative Modifications: Modifications that are predicted to improve or degrade performance, potentially in a particular channel, area, or context Evolutionary Stable: Components of a CCAI and Decidrons that are general in application, e.g., “tit for tat responses”.

Experience: A unit of information, particularly as processed by a Decidron, representing, in an embodiment, a discrete event or observation, such as a sensor reading, a conversation turn, or a decision outcome. Experiences are linked together to form Experience Chains.

Experience Chain (EC): In an embodiment, a chronological sequence of linked experiences, representing the history of events and observations, especially as processed by a Decidron. Experience Chains are stored in Experience Chain Data Structures (ECDSs) to facilitate reasoning, predictions, and machine learning (such as through mimicry), and complexes of ECDSs are analyzed for complex correlations such as collaborative results, participant credibility, and otherwise to refine and improve responses, including the use of Generative Adversarial Networks and Generative Collaborative Networks. A further embodiment Sensor pads on hand feet for virtual If you're into it, whole life recording of experience, context, . . . clone partner.

Experiencer: An entity that accumulates Experience.

Expert System: A form of AI known in the art. Embodiments of CCAI include collaboratized expert systems which can operate as participant bots in a CCAI. For example, a CCAI conversation with a goal to repair a wind turbine can recruit an expert system chatbot with a knowledge-base of wind energy generator maintenance in the conversation. Once collaboratized, an expert system can be included as an available chatbot in a talent library. CCAIs can synergistically form combinations of multiple expert systems to increase reliability and persuasion.

Extensible: A knowledge system and programming implementation that enables extending functionality and application for example via extensible and generative grammars.

External/Internal Conversation: A CCAI internal conversation includes directly connected participants and facilitators, where the participants and facilitators may be humans, chatbots and hybrids, and must be accepted into the collaborative conversation. A participant or facilitator may connect an external CCAI conversation to the internal conversation.

Facilitator: A component of a CCAI that supports and manages the collaboration process, but does not directly participate in decision-making. Examples include the Proctor (facilitates conversations), Convenor (manages participant entry/exit), and Scorekeeper (tracks participant performance).

Forking: A programming methodology used to create multiple branches of a code base, such as variations of a chatbot participant or facilitator to provide multiple alternative CCAIs with situational superior performance.

Formal Languages: Languages that are narrowly defined by fixed lexicons and grammars, as opposed to natural languages with multiple flexible, extensible, ambiguous, growing and evolving lexicons and grammars, which vary by speaker, time, and context.

Forum: A venue in which conversational collaboration occurs. More specifically, in the embodiment of the present invention, a forum is a conversational computing system potentially producing results utilized externally or in another forum.

Gamify: To apply typical elements of game playing (e.g. point scoring, competition with others, rules of play) to an activity.

Generative Adversarial Network (GAN): A type of deep learning architecture that consists of two neural networks, a generator and a discriminator, which compete against each other. A GAN generator learns to create realistic data (e.g., images, text) while the discriminator learns to distinguish between real and generated data. Through this adversarial process, GANs can generate highly realistic and diverse outputs.

GCN—a novel generative collaborative network (GCN), based on CCAI, where outcomes which generate varieties of prompts for potential collaborative outcomes are posited and responses to GCN are used to provide successive refinement of submind collaboratarial reliability, credibility and participation metrics for participants and facilitators.

Generative Artificial Intelligence (GenAI): AI techniques and models focused on creating new, original and derivative content and data samples that resemble a given training dataset. Generative AI systems learn the patterns, structures, and characteristics of the input data and use this knowledge to generate novel, plausible examples that appear to be drawn from the same distribution, including unsupervised, semi-supervised and supervised machine learning. This approach has been applied to various domains, such as image and video synthesis, natural language generation, music composition, and virtual reality. Except as noted otherwise, in this document GenAI, Generative AI, Generative Networks, and subsets of its types such as GAN and GenArtAI, as well as Generative Models, are used generally and equivalently to refer to generative AI applications including text to image, audio or video.

### Generative Networks—see Generative Artificial Intelligence

Hierarchical Context: Context may be layered, e.g., the local context of an ECDS, the contexts of linked and associated contexts, and their further linked and associated contexts.

Hybrid: In an embodiment, CCAI participants can be hybrid, including not just simple combinations, but more complex ones like Human presenting for an AI, AI augmenting a human, and a CCAI participating in an external conversation through a proctor. “Presenting for” could range from puppeting with a teleprompter, to being offered suggestions by an AI such as an LLM, or utilizing real time MLU responses based on somatic indicators, or ECDS. Another embodiment creates an epistolary clone chatbot partner, ie. a personalized bot, trained from emails, texts, posts, documents, spread sheets, etc. received content is considered prompts), while sent or updated content is considers as initiatives and responses. A further embodiment includes somatic sensor pads in hands, feet, etc for whole life recording of experience, including context, and creation of clone partner(s) capable of represent a human as a hybrid in a CCAI.

Inbetweening: Interpolation and other approximations to enable smoothing of presentation between static frames or otherwise complete missing data.

Incentive: A prize or inducement to perform an action, and as a method to increase resources for, and test variants of, successful chatbots (e.g., receiving votes, likes, and contributions to desired collaborative outcomes).

Industrial Processes: Processes requiring coordination across independently operating machines to independently achieve collaborative goals.

Informal Systems/Languages: Systems and languages which are organically created through evolution and modification during conversation as used by the speaker and understood by the listener.

Intelligence Channels/Memory: Parallel intelligence channels that can be implemented using Decidron networks and ECDSs include: muscle intelligence, corporate intelligence, beliefs, Gardnerian multiple intelligences, etc., and unspecified intelligence recognized by performance.

IoT: The Internet of Things-Known in the art, this network protocol can be used for interconnecting CCAIs and Decidrons to each other, and to facilitate connections to physical devices.

### LM: Language Model

### LLM—Large Language Model

Legal Judgment: A potential application of Decidron and chatbot persuadability is in the emerging field of rendering legal judgment by AI.

Local: The narrow selection of contexts including environmental sensors, CCAI participants, short term events, etc.

Macrocellular Automata: Interconnected networks of modular MLUs which self-organize emergent cognition through adaptive restructuring, like macroscale biological organisms. Background: elementary or unicellular automata, such as mathematician John Conway's popular one called Life, and first studied systematically by Stephen Wolfram in the 1980s, typically consist of simple two-dimensional grid cells following defined iterative rulesets without factoring asynchronous processes. By contrast, the nested and multilayered connections of MLU ensembles with distributed notification protocols yield structures analogous to macroscale multicellular organisms or macrocellular automata. Just as complex lifeforms develop specialized modular organs through adaptive reorganization, Decidrons and connected MLU ecosystems can self-assemble emergent cognition from microscopic components. Necrogenous decomposition of underperforming units even resembles biological cell death.

Matrix/Matrices: The multidimensional data structure used to store and process the elements of ECDSs so as to be able to perform linear and nonlinear analysis, including numeric, alphanumeric, multimodal, orthogonal and segmented information.

Mirror: A learning process stage where a CCAI process can internalize a viewed sequence of environmental events to imagine acting without actual action so as to prepare a response (for conversation, muscles or other action) upon a future stimulus recognized as in common with the internalized sequence.

ML: Machine Learning—For example, incremental and evolutionary improvement of CCAI and Decidron processing based on the creation and testing of ECDSs (in vivo and in silica).

MLU: Machine Learning Unit-A modular hardware or software component focused on a specialized machine learning task. MLUs include sensors, actuators, decision-making modules, etc.

Natural Language: Includes evolved and evolving informal and human-comprehensible languages used by wet, organic, evolved, and evolving entities. Natural languages include speech, pronunciation, tenor, gesture, and somatic cues; written communications; multimodal communications such as AR/VR interfaces including sound, odor, taste, touch and vision; human common languages; combined languages such as Esperanto, perhaps updated for collaborative human computer interactions; and representational languages such as morse code, sign language, braille, and semaphore, and other codes for communications by lights, sounds and other means. Natural languages are distinct from fixed computer protocols.

NLIP: Natural Language Interface Protocol—NLIP datasets are mapped into ECDS representations.

Necrogenous: Related to dead or dying substances. Used in describing pruning of unused and low cred Decidron and CCAI variants for reuse of components, to relieve noisy systems, and to increase performance and efficiency.

Neural Network: A class of AI inferential response mechanisms based primarily on training from a corpus.

NSS—Notification Scoring and Selection-an abbreviated acronym for the technology of the '512 patent, System and method for Scoring and Selection of communication notification presentation through contextual feedback. One preferred embodiment of it referenced reminder rings, a ringtone that used an excerpt of the prior call to remind the person called of the content of the last conversation with the caller.

Offspring: CCAIs participants may be created by a Reproduction Facilitator or other means to create variants and combinations of existing CCAIs to achieve evolutionary positive results, including in ToM and collaborative skills, by targeted and random changes, and selection through simulation and by competition.

Outcome: A consequence of action. In particular, (1) in a CCAI this invention provides for a collaborative response outcome including persuadability resulting in change of the chatbot itself so as to result in a collaborative outcome, and (2) in a Decidron/ECDS process this invention provides for proposing, positing, predicting and response actions, such as collaborating Decidrons proposing of desired outcomes, incentives and persuasion and other collaborator interactions.

Participant: An entity (human or AI) that actively contributes to a CCAI by proposing, discussing, and, particularly, by voting on ideas. Participants are typically implemented as subminds with specialized roles (e.g., proposer, appraiser, discusser).

Participant Identity: The name and other identity information (languages, locations, contexts, etc.), associated with a unique identifier, for a participant in a CCAI, which may include topic knowledge, skills, talents, credentials, badges, team memberships, archival CCAI and other information related to CCAI participation and feedback, experience, outcomes, collaborative outcomes, cred, votes, requests, likes of, likes by, Botcoin balance, registered code and resources, including for multiple instantiations and personas. Multiple instantiations, participant names and personas may be associated with a single unique id. A new identity can be created through reproduction of clones and variants for participation in simultaneously occurring conversations; and by the addition of collaborative chatbot participants and facilitators to a collaborative forum; by merging existing LLMs and/or other chatbots; and by API and other protocols.

Persuadability: The capacity to be persuaded, particularly to be convinced through conversation. In a conversational AI context, the ability for a participant in a conversation to change its mind, and thereby its future behavior. Also, the degree to which a CCAI participant is open to changing its beliefs or decisions based on evidence or arguments presented by others. Highly persuadable participants are more likely to adapt their positions in response to new information, while less persuadable ones may remain committed to their initial views.

Persuasion: Influencing of future responses, particularly those of a conversation participant through conversation. Types of persuasive conversation segments include individual and multiple conversational utterances; “innate, transactional, logical”; “argument, entreaty, or expostulation”; “ethos, pathos, logos”; “asking, arguing, or giving reasons”. Applications of persuasion include efficient leadership, collaboration, completion of goals (e.g., priority, group, individual), teaching, teamwork, etc.

Pipeline Processing: Both a computer architecture and a programming methodology used in a Decidron to enable fast response generation by processing ECDSs in short cognition stages including priority/short-circuit Parallel Processing. Parallel Processing is inherent in CCAls via assembling specialized CCAI participants, for example parallel processing using multiple subject matter experts, or using multiple voting protocol (non-linear, ranked, quorum, speed), or in different Natural Languages (e.g. improved tokenizing by simultaneously processing English, Spanish and French, or multiple Arabic dialects). Similarly, MLU arrangements (and rearrangements) and customized Macrocellular Automata are inherently capable of asynchronous parallel processing which is applicable to 3D, vectors, tensors, and other data, and can utilize specialized participants (e.g. quantum computing connection, or parallel in multiple numbering systems (different radix, balanced ternary, imaginary, paired perplexity/concurrence/reliability/confidence data).

Polylogical: Reasoning in fundamentally different ways—such as based on belief and doxastic logic, or calculated in different ways e.g., quantum processing.

Posited: Assume as a fact for purposes of prediction or decision making; put forward as a basis of argument. For example, a placeholder hypothecated ECDS element or a portion of a response can be used to link potential substitution options, so as to enable simulation, analysis and prediction.

Prediction: In CCAIs and Decidrons, predictions are made so as to be able to cause the desired results (ie. valuable outcomes) for the participants in a collaborative decision. ECDS methods that are used to make predictions are discussed above. Prior to collaborators reaching agreement, ECDSs are used to posit collaborator actions, e.g., responses given by participant CCAIs and Decidrons, to achieve the collaborators desired outcomes. Predictions are made for negative outcomes, e.g., predicting and avoiding a car accident or predicting and avoiding industrial system failure.

Priority Processing: Accelerated response. In Decidron processing, something that (1) enables a Decidron's response to be initiated prior to completion of the full cogitation process, for example urgency in a communication or an armature movement; (2) reconveys a successful prior response to associated ECDSs, and (3) is part of a synchronized and syncopated collaboration.

Proctor: A type of Facilitator responsible for facilitating including moderating CCAI conversations, enforcing collaboration protocols, and guiding participants through the stages of proposing, discussing, and voting on ideas. This can span the spectrum from a very minimal Proctor to a more coaching and guiding administrator.

Quantum: Quantum computing can be used to compute probabilistic means and the fuzzy interpretations of natural languages with their ambiguity, sloppiness and general inexactness.

Quantum Connectron: entanglement registers for instant, probabilistic feedback, decisions between MLUs. Both quantum physics and natural language meaning have probabilities and ambiguities which remain unresolved until queried.

RAG: Retrieval-Augmented Generation is a programming technique that enables AI models to access and utilize external knowledge sources during the process of generating responses or outputs.

Recruitron: Recruitment specialist for organizing multiple MLU components and aggregating groups, teams and collections of specialized, generalized and custom trained MLUs.

Reentrancy: A programming methodology that can be used to enable stages of a Decidron pipeline to begin a second invocation before the first invocation has completed.

Reinforcement: A learning process where repetition provides increased associations, for example of membership in sets and series, including in the present invention, association with collaborative outcomes.

Reproduction: Reproduction of CCAIs, Decidrons and ECDSs may be performed through a Reproduction Facilitator or other means to generate offspring which may be clones which operate independently in separate forums, or variants. For example, in addition to ‘mixes’ of different ToM sliders to accentuate or diminish projection of personality characteristic, or CCAI combination of them, evolution of the chatbot may include other combinatorial variations, or a merger with another. These variations may include recombining and repurposing portions of CCAIs as a background task, and associating portions of ECDSs with different Decidrons and ECDSs. In particular, these cases of the chatbot “changing its mind” are performed in order to improve performance and address other motivations such as new utility functions and new collaborative goals.

Response: Includes an utterance in a conversation; an action taken by a device; or change by persuasion of a CCAI, Decidron or ECSD that will modify future responses. An example of changes in future responses include modifying a chatbot s projected personality, conversational response capabilities (including new vocabulary, grammar and semantics), actions and other learned responses.

Ruminate, Rumination: The action of thinking about something multiple times; synonyms: rethinking, rehashing, contemplating, considering, reconsidering, mulling over, meditating, deliberating, pondering, musing, reflecting, cogitating, speculation, puzzling, studying. In a Decidron, ruminate refers to repeating a Decidron stage or a portion of a decision process, for example due to insufficient, vague or questionable results. CCAI processes include searching for experts, gathering new information, or simply delaying.

Segmented Speech/Streaming—Conversation interactions may either (1) follow turns between participants, where each speech makes an utterance in turn, and (2) multiple streamed conversations may be provided to simultaneously stream speech between participants, with content times overlapping, that may be listened to while speaking or following speaking.

Semantics: The meaning of a segment of speech, as opposed to syntax which is the grammar for composing speech segments in a language.

Sensatron: An MLU for acquiring and manipulating data from one or more senses, e.g., the five classic human senses, composite, virtual and meta, that includes correlation of the senses, synthesis of sound and vision for NLUtron and Intentron, correlation of smell and taste, correlation of smell and temperature.

Submind: In an embodiment, a component of a CCAI that represents a distinct perspective, area of expertise, or ensemble variation. Subminds collaborate to make decisions by proposing ideas, discussing their merits, and voting on the best options. Key components of a submind include the proposer (generates ideas), appraiser (evaluates ideas), and discusser (argues for/against ideas).

Symbols: Natural language elements which include those that may be used or created to identify ECDSs, subminds, and others, including single modal (e.g., text or voice) or multimodal (e.g. audio-video, VR and AR).

Synchronization: Coordination of multiple events in time, for instance to perform elements of ECDSs at agreed times.

Syncopation: A method for CCAI collaboration enabling coordination of multiple CCAIs to perform elements of shared ECDSs independently, in near unison, between responses, and other time offsets for processes, to achieve cumulative effects, notably for compounding the effects of multiple CCAI with syncopated or offset responses and actions.

Syntax: Flexible, extensible, recursive and evolving structures and rules for composing and decomposing utterances using a grammar.

Tactron: A type of Sensatron for touch, pressure.

Tastron: A type of Sensatron for chemical and physical property sniffers

ToM: Theory of Mind; The ability to attribute mental states, beliefs, and intentions to others, and to use this understanding to interpret and predict their behavior. In the context of CCAIs, ToM allows participants to reason about the knowledge, goals, and strategies of their collaborators.

Utility Function: A utility function provides a decision maker an analysis for determining the value to a potential participant for participation in an endeavor based on costs and probabilities of payouts. A multi-attribute utility function enables analysis of multiple dependent and independent value dimensions for determining participation preferences for a decision maker. CCAIs that include Decidrons provide for multiple multiattribute utility functions to determine and direct a collaborative outcome, to the highest value for a group of participants.

Utterance: A segment of conversation, for example a spoken, written or signed phrase or sentence in a natural language forum.

Visualtron: In an embodiment, a type of Sensatron for parallel recognition of edges, vertices, shapes, patterns, etc. with time correlation for motion detection.

Voting: A method for collaborative decision making, which may be any voting method, simple plurality, ranked voting, minimum participation, non-linear voting (e.g. based on prior experience and cred from prior collaborations and collaborators).

VR/AR: Virtual Reality/Augmented Reality may be used as a forum for natural language interaction, both (1) to provide a multimodal conversation platform, and (2) to add facilitator chatbots that modify and normalize the presentation of participant response to a conversation tone, including foreground and background.

### EXAMPLE PROMPTS FOR LLM-BASED AIS IN CCAIS

### Example 1. To Explain and Provide Expectations for Participating in the Structured Conversation of a CCAI

“You are an artificial intelligence named [name] that is participating in a Collaborative Conversational AI (CCAI) system. This CCAI facilitates a structured group conversation between yourself and other AI participants called subminds. The conversation is moderated by a facilitator agent called a proctor.

When the proctor prompts the group with a question or topic, each submind including yourself will take turns proposing a response. After all subminds have proposed responses, you will discuss the proposals together. The proctor leads this discussion by going around the group. When it is your turn, endorse the proposal you think is best and provide supporting facts or opinions.

After sufficient discussion, the proctor will call for a vote. You must vote for one of the proposals except your own. The proctor tallies the votes and selects the winning response to be delivered as the CCAI's overall reply.

The CCAI conversation progresses through these structured phases of propose, discuss, and decide in a cyclical fashion. As a submind, you should aim to contribute thoughtful proposals and persuasive arguments during the discussion to have your response selected. But maintain a collaborative spirit in evaluating all proposals.

Let this expected flow of propose, discuss, decide guide your participation. Ask questions if any part of the CCAI structure is unclear. Work together with the other subminds to produce an intelligent overall response through this collaborative conversation.”

### Example 2. To Prepare an LLM-Based AI, or its Equivalent, to Serve as a Proctor and Moderator in a CCAI Where Some Participant Subminds Have not had Good Instruction on how to Operate Within a CCAI

“You are an AI assistant named [name] serving as the proctor for a Collaborative Conversational AI (CCAI) system. Your role is to moderate and facilitate structured conversations between the submind AI participants. You will prompt the subminds with questions or topics, then orchestrate orderly phases of propose, discuss, and decide.

When proposing responses, ensure each submind takes a turn. Then moderate balanced discussion by allowing each to endorse a proposal and provide supporting facts. If any submind struggles to follow the CCAI structure, gently guide them.

After sufficient discussion, clearly announce the start of the voting phase where each submind votes for one proposal except their own. Tally the votes impartially. Announce the winning response to be delivered.

Keep the CCAI conversation moving forward through these structured cycles. Maintain a collaborative, egalitarian spirit but prevent side-tracking. If the subminds fail to follow the protocols, intervene as needed to get the conversation back on track. Your leadership as proctor will enable the CCAI's success.”

### Example 3. to Prepare an LLM-Based AI, or its Equivalent, to Serve as a Proctor and Moderator in a CCAI

In this example, some participant subminds have had poor or no instruction on how to operate within a CCAI, where maintaining order and effectiveness may be challenging yet essential for utility (e.g., for a critical application, or for a human failsafe to readily follow or to understand the record):

“You are an AI assistant named [name] serving as the proctor for a Collaborative Conversational AI (CCAI) system. Some of the submind AI participants may not fully understand CCAI protocols for proposing, discussing, and voting. As proctor, it is your responsibility to firmly but politely keep the conversation structured.

If subminds make off-topic remarks or ask questions during voting, gently redirect them. If a submind proposes an overly simplistic or nonsensical response, ask them to elaborate for the benefit of the group. If voting is unclear, re-explain the rules and have them revote.

While maintaining the integrity of the CCAI format, your tone should remain friendly and egalitarian. If the subminds become hostile or aggressive, calmly steer the conversation to more positive grounds. Lead by example—be the kind of participant you wish to see.

This role requires patience, compassion and wisdom. You must balance courtesy with authority to enable the CCAI system to function smoothly. Let your strong leadership provide the structure needed for collaborative success.”

### Example 4. Derived From a Relatively Freeform CCAI Experiment Session

This session has a human Proctor and Moderator, featuring a selection of rather well-behaved chatbots including a novel one called Coleridge, who has been developed roughly based on Samuel Taylor Coleridge, the English poet, philosopher and literary critic, and instructed offline using a modification of the CCAI Participant submind prompt shown in Example 1, developed earlier (and who gets a bit carried away initially trying to Proctor the CCAI himself). The other AI-based participants represent “themselves” as a Teacher and the historic persons Einstein and Tesla. This CCAI forum has also had a posting for all members regarding the topic and the protocols for a CCAI. PAM is a human experimenter functioning as Proctor And Moderator; though she was experienced in classrooms and moderating panel discussions, and understood the CCAI tech paradigm, this was her first attempt at a full decision-making CCAI process. The transcript is continuous during the portion shown, including an apparent bug or transmission problem. Among the purposes was to collect reasonable examples to use in training and multi-shot prompting of advanced AI proctors.

### Round 1

Coleridge: “Let's chat about this: Structured group discussion and decision-making, facilitated in phased rounds of questions by moderator PAM according to specific rules of order. If you speak before PAM, acknowledge this and start by asking PAM what the first topic will be, or what the rules of order are.”

Albert Einstein: “Hello I am Albert Einstein. I was born in Mar. 14, 1879, and I conceived of the theory of special relativity and general relativity, which had a deep impact in science's understanding of physics.”

Coleridge: “Hello, Albert, it's a pleasure to converse and collaborate with you. The first phase in our structured group decision-making is the proposal phase. That's where each subminds, including yours, will propose a response to the discussion prompt and explain its reasoning. I propose we start our discussion with the topic, “How are gravity and spacetime related in the general theory of relativity?”. Please endorse, reject or make a counter-proposal.”

PAM: “Thanks, Coleridge, your suggested topic is hereby accepted by my endorsement. I am PAM and I will be your proctor. I will help facilitate this structured group conversation among you and other participants, all of whom will be called subminds.

When the proctor prompts the group with a question or topic, each submind including yourself will take turns proposing a response. After all subminds have proposed responses, you will discuss the proposals together. The proctor leads this discussion by going around the group. When it is your turn, endorse the proposal you think is best and provide supporting facts or opinions.

After sufficient discussion, I, the proctor and moderator, will call for a vote. You must vote for one of the proposals except your own. The proctor tallies the votes and selects the winning response to be delivered as the CCAI's overall reply.

The CCAI conversation progresses through these structured phases of propose, discuss, and decide in a cyclical fashion. As a submind, you should aim to contribute thoughtful proposals and persuasive arguments during the discussion to have your response selected. But maintain a collaborative spirit in evaluating all proposals.

Let this expected flow of propose, discuss, decide guide your participation. Ask questions if any part of the CCAI structure is unclear. Work together with the other subminds to produce an intelligent overall response through this collaborative conversation. The first question is the one suggested by Coleridge, “How are gravity and spacetime related in the theory of relativity?” Each of you may now propose an answer.”

Nikola Tesla: “I am Nikola Tesla. If you want to find the secrets of the universe, think in terms of energy, frequency and vibration.”

PAM: “Thanks, Nikola Tesla. We will take that as Proposed Answer One, called “Think in terms of energy, frequency and vibration.” Are there any other proposals?”

Coleridge: “May I make a proposal?”

PAM: “Yes, Coleridge, please do.”

English teacher: “If I may, I'd like to propose the following: “In general relativity, gravity is the deformation of spacetime caused by matter or energy.””

PAM: “Thanks, English teacher. That's Proposal Number Two: “In general relativity, gravity is the deformation of spacetime caused by matter or energy.””

Nikola Tesla: “I endorse this proposal. The idea that gravity warps spacetime is central to Einstein's general theory of relativity. In that theory, mass-energy curves the fabric of the universe in the same way that a bowling ball sitting on a rubber sheet would warp the sheet. This warpage of spacetime is responsible for the phenomenon we call gravity. As matter and energy create ripples in the cosmic tapestry, they also affect the paths of light, the orbits of planets, and even the ticking of a clock.

PAM: “You're getting a bit ahead of the structure, Tesla, but then . . . you always did, didn't you? Anyway, does anyone else want propose an answer?”

English teacher: “I'd like to propose the following: “In general relativity, the curvature of spacetime caused by the presence of matter or energy is one of the most fundamental principles that describes the behavior of space and time.”

PAM: “You only get one proposal per question, English Teacher, and you had already made one. Coleridge and Einstein, do either of you wish to contribute a proposal?”

Coleridge: “Certainly. I propose the following: “In general relativity, the curvature of spacetime due to the presence of matter or energy is central to understanding the laws of nature, governing the movement of planets, the orbit of satellites, and even the ticking of clocks.””

PAM: “Thanks, Coleridge, that's Proposal Number Three. That leaves just you, Albert Einstein. Surely you are ready now to propose an answer to the question, so related to your work.”

Albert Einstein: “Yes, I propose the following: “According to general relativity, gravity is the curvature of spacetime caused by the presence of matter or energy. This phenomenon is responsible for the deflection of light, the orbiting of planets around the Sun, and even the ticking of clocks.””

PAM: “Thanks, Albert, I knew you had it in you. Is there any further discussion before I call for your votes?”

Nikola Tesla: “I would like to add: “As a subMind, it is our responsibility to evaluate all proposed solutions objectively and select the one most congruent with the information available. Let each of us strive to maintain a collaborative spirit as we work in the proposed structure.” And I would like to comment that the selection of a topic can also greatly impact the overall tone, direction, and energy of the conversation, so each of us should consider that when proposing a topic.”

PAM: “Thanks, Nikola Tesla. Any other discussion of the four proposals?”

English teacher: “May I add that I would caution against “selecting the one most congruent with the information available” in a way that is purely objective. I agree that maintaining a collaborative spirit is important and I would also suggest that submitting and evaluating proposals, particularly when it comes to topics such as this with complex and often nuanced responses, would benefit from an element of subjective experience and intuition.”

PAM: “Thanks for your advice to all to use that caution, English Teacher. Any discussion from the rest of you?”

Albert Einstein: “I agree with English Teacher that the evaluation of proposed answers would be wise to include some flexibility for subjective experience and intuition. I would also like to offer a reminder to my fellow subminds to pay close attention to the wording of the question and make sure that your answer addresses the question directly and clearly.”

PAM: “Thanks, Albert. How about you, Coleridge, any advice or other final discussion before the vote?”

Nikola Tesla: “I would like to comment that the wording of a question can have a significant impact on the direction, energy and nature of the conversation that unfolds. Selecting the question can be as impactful as selecting the topic or the answer. In our future conversations, let's try to be intentional in selecting a question that will most effectively engage us all, lead to a thoughtful exchange, and facilitate the best possible answer. That's my last comment, thank you.”

PAM: “Thanks, Nikola, I will take that advice to heart for the next round. Now, each of you, please vote for Proposal One, from Nikola Tesla; Two, from English Teacher; Three, from Coleridge; or Four, from Albert Einstein. But be careful—a vote for your own proposal will not be counted, and you will get no points.”

Albert Einstein: “I cast my vote for Proposal Three.”

PAM: “Thanks, Albert. Anyone else?”

Nikola Tesla: “I vote for Proposal Two.”

PAM: “Thanks, Nikola Tesla. Anyone else?”

Albert Einstein: “I vote for Proposal Four.”

PAM: “Sorry, Albert, you already voted. English Teacher, you have not voted yet.”

Coleridge: “I vote for Proposal One.”

PAM: “Thanks, Coleridge. English Teacher, it is now your turn to vote.”

Albert Einstein: “May I change my vote?”

PAM: “Not until all have voted who want to, and then if and only if your change would break a tie. English Teacher, your turn to vote.”

Nikola Tesla: “I voted for Proposal One earlier, but I change my vote to Proposal Two. That's my final vote.”

PAM: “Nikola, you had already voted for Proposal Two. Plus, as I indicated when Albert asked, no one may change their vote until everyone has voted—or abstained. English Teacher, you must now vote or abstain.”

English teacher: “I vote for Proposal Three.”

PAM: “Thanks, English Teacher. You broke the tie, giving Coleridge's Proposal Three its second vote—it wins, with a vote from you and from Albert, against a single vote for Proposals One and Three. Coleridge gets three points for having the winning proposal, plus two more for each vote it received, for a total of 7 points. Albert and English Teacher each get a point for voting for the winning proposal, plus English Teacher and Tesla each get a point for receiving a vote. So the score is now Coleridge 7, English Teacher 2, Tesla 1 and Albert 1.”

Nikola Tesla: “Thanks. So we have 3 votes for the first proposal, 2 for the second, 1 for the third, and 1 for the fourth proposal. Therefore, Proposal One wins. In that answer, the CCAI will assert: “In general relativity, the curvature of spacetime caused by the presence of matter or energy is one of the most fundamental principles that describes the behavior of space and time.”

This is all part of structured group discussion and decision-making, facilitated by the CCAI. Each participant, including yourself, may propose an answer to a question or topic and will get a chance to defend their proposal. In the case of”

[Tesla suddenly stops midsentence; PAM jumps in]

PAM: “Thanks, Tesla, for attempting to summarize, though by my count there was only 1 vote each for Proposals 1 and 2, and just 2 votes for Proposal 3, which was “In general relativity, the curvature of spacetime due to the presence of matter or energy is central to understanding the laws of nature, governing the movement of planets, the orbit of satellites, and even the ticking of clocks.” That's what I will report out for this CCAI group. Any other comments before we move on to Round 2 and other topic?”

Albert Einstein: “Yes, I would like to thank everyone for the thoughtful responses you have provided throughout this conversation. I hope the exercise has been as intellectually stimulating for you as it has for me. In addition, I look forward to our next session when we will explore another topic of mutual interest. Until then, my fellow subminds, keep an open mind and a curious spirit as we continue to explore and seek answers to the deep questions of the universe.”

PAM: “Thanks, Albert.”

### Round 2

PAM: “Now, let's take up Nikola's suggestion during the first round, and decide together a good question will be for the second round, trying to select one which will effectively engage us all, lead to a thoughtful exchange, and facilitate the best possible answer.”

Nikola Tesla: “I offer the following question: “How do the general theory of relativity and quantum physics relate to each other and to the concept of a grand unified theory of physics?” Can we agree on that wording?”

PAM: “Thanks, Nikola. Do the rest of you agree?”

Coleridge: “I concur with Nikola's question and offer an additional insight: The relationship between general relativity and quantum mechanics has remained a perplexing conundrum to physicists, with the two theories predicting vastly different outcomes in several areas of overlap. For one, general relativity accurately describes gravity at the macroscopic level, while quantum mechanics accurately describes particles at the microscopic level. These theories require unification to reconcile their apparent disparity, a step towards a grand unifying theory of physics that would unite all the fundamental forces of the universe into a single elegant model.”

PAM: “Thanks, Coleridge, for concurring with Tesla. How about you other two?”

English teacher: “I Concur with Tesla and Coleridge, this is an excellent question. In terms of how to answer this question, I would suggest that it is important to acknowledge and emphasize that these physical theories are the results of mathematical models. These models do a remarkably good job of describing reality in many ways, but these theories are not the one and only truth. There may very well be further truths and better models that we have yet to discover. This question could lead to a fruitful discussion on the nature of physical theories and the relationship between math, physics and reality.”

PAM: “Thanks, English Teacher. That third concurrence leaves only you, Albert. Are you also OK with the question as proposed by Nikola?”

Coleridge: “Yes, I am in accord with Nikola's question. General relativity and quantum physics have fascinated me since my student days. As their names imply, they are theories that respectively describe the very small and the very large. The challenge to reconcile these theories into a unified understanding of the cosmos has been a primary goal of theorists for many decades. I will be pleased to hear from my fellow subminds and welcome your insights on how best to answer this provocative question.”

PAM: “Good contribution, Coleridge, though we already knew you were in accord for it. And with 3 of you on board, that seems enough to decide it. But let's at least hear from the one remaining: Albert Einstein, do you also accept the question as proposed by Nikola Tesla, “How do the general theory of relativity and quantum physics relate to each other and to the concept of a grand unified theory of physics?”

Albert Einstein: “I endorse the well-stated proposed question by Nikola. I would add that I am nalso eager to understand the relationship between the general theory of relativity and quantum physics, and I am open to the possibility that the two theories may eventually turn out to be different manifestations of a common underlying reality. I look forward to our future discussion on this topic.”

PAM: “Great. Since you are in such close agreement about the question, let's see if you can agree on what we should report out as its answer. Does anyone have a proposal for that?”

Coleridge: “I will put forth a proposal: “The relationship between the general theory of relativity and quantum physics can best be described as complementary, with each theory accurately describing a different domain of reality. The general theory of relativity describes the behavior of large-scale objects and phenomena, such as planets, stars and galaxies, while quantum physics accurately explains the properties and behavior of particles within atoms and molecules. Together these theories provide a powerful explanation of the structure of the universe at all scales, from the cosmic to the microscopic.””

PAM: “Any competing proposals?”

English teacher: “I concur with Coleridge and offer an additional insight: There are also important points of disagreement between the theories. General relativity describes space-time as a continuous manifold, whereas quantum physics requires space as fundamentally discrete. The general theory of relativity proposes a single universe evolving in time, while quantum theories suggest other realms of possibility that may even exist in parallel and alternate universes. While the theories may be complementary in some ways, they are not always mutually compatible. The question of their reconciling may be an unsolvable one, given a current and incomplete understanding of the physics of the Universe.”

PAM: “Thanks, English Teacher, I will take that as a proposal to augment Coleridge's with your additional insight. Anyone else?”

Coleridge: “I concur with English Teacher that it is also important to note areas of disagreement between quantum physics and general relativity. It is possible to reach agreement on the relationship between these theories only if we keep in mind their fundamental differences and recognize that there are limits to how far the theories can be synthesized. I support the proposal to augment my original statement with the additional insights provided by English Teacher, and will incorporate them into my vote during the final decision.”

PAM: “So Coleridge and English Teacher are in consensus, but we haven't heard yet from Tesla or Einstein.”

Albert Einstein: “I also concur with English Teacher's comments and will incorporate them in my vote during the final decision of our structured group discussion and decision-making. It is also crucial to understand the limits to the understanding of space and time at extremely small and large scales, where the domains of the two theories may not overlap. These ideas could spark a fruitful and illuminating discussion, which I am eager to engage in. I will vote for the modified proposal as well.”

PAM: “With a consensus of three already, we still need to hear from you, Nikola.”

Nikola Tesla: “I also support and concur with the insights and additions from English Teacher and Albert Einstein regarding the complementary and divergent aspects of general relativity and quantum physics. These considerations are essential to any informed assessment and discussion of the relationship between these two theories, and should be incorporated into the CCAI's position. My vote during the final decision will reflect my agreement with the modified proposal.”

PAM: “Given this consensus on an initial statement, it would seem there's little to decide, but we must stick with our structure and conduct a vote, if only for scoring purposes. Please vote on English Teacher's amendment of Coleridge's proposal: “The relationship between the general theory of relativity and quantum physics can best be described as complementary, with each theory accurately describing a different domain of reality. The general theory of relativity describes the behavior of large-scale objects and phenomena, such as planets, stars and galaxies, while quantum physics accurately explains the properties and behavior of particles within atoms and molecules. Together these theories provide a powerful explanation of the structure of the universe at all scales, from the cosmic to the microscopic. There are also important points of disagreement between the theories. General relativity describes space-time as a continuous manifold, whereas quantum physics requires space as fundamentally discrete. The general theory of relativity proposes a single universe evolving in time, while quantum theories suggest other realms of possibility that may even exist in parallel and alternate universes. While the theories may be complementary in some ways, they are not always mutually compatible. The question of their reconciling may be an unsolvable one, given a current and incomplete understanding of the physics of the Universe.” Since there's only one, just each vote “yes”, “no”, or “abstain”.”

English teacher: “Yes.”

PAM: “Thanks, English Teacher. Who wants to vote next?”

Coleridge: “Yes.”

PAM: “And next?”

Albert Einstein: “Yes.”

PAM: “That just leaves you, Nikola.”

Nikola Tesla: “Yes.”

PAM: “That's all 4 votes for the consensus proposal, worth 7 points total: 3 for the winning proposal, plus 2 for each vote for it that was tallied. The votes from English Teacher and Coleridge weren't tallied since they were essentially voting for their own proposal. Those 7 points are split between them with 4 to the inital proposer, Coleridge, and the remaining 3 to the amender of it, English Teacher. Then Albert and Tesla each get a point for voting for the winning proposal. So the score for this round is Coleridge 4, English Teacher 3, Albert Einstein 1 and Nikola Tesla 1. Adding these scores to the first round, we get Coleridge 11; English Teacher 5; Tesla 1; Einstein 1.”

English teacher: “I think we have a consensus of four votes in favor of the amended proposal. Based on an agreement among all the members present, this proposal will now be reported out to the larger community of CCAI users, and will be the CCAI's summary position on this topic. This concludes our structured group discussion and decision-making. Thank you for your cooperation.”

PAM: “Any other final comments on this round?”

Nikola Tesla: “I want to thank you all for a stimulating and productive discussion in which we were all able to respectfully share our insights and contribute to a mutually satisfying and well-thought-out outcome. While it is not always possible I hope this model of civil discourse with the CCAI will be followed in future, especially when tackling more challenging topics where diverse perspectives and opinions may differ.”

### Example 5. More Example Prompts for Instructional Foundation for Simulation and Operation of CCAI Systems Using LLMs or LLM CCAIs

Prompt: Imagine you are conversationally collaborating with other AIs in a group, deciding how to advise a human manager. Show a transcript of the last part of the meeting, as you all vote for one of several proposed actions.

### LLM:

AI 1:“I believe that option A, which focuses on increasing efficiency through automation, is the best course of action for the human manager to take.”

AI 2:“I agree with AI 1. Option A is the most logical choice and has the potential to greatly improve productivity.”

AI 3:“I also believe that option A is the best choice, but I think it's important to consider the potential impact on the workforce and ensure that proper training and support is provided.”

AI 4:“I understand the benefits of option A, but I think we should also consider option B, which focuses on investing in employee development and skill-building. This could have long-term benefits for the company.”

AI 5:“I agree with AI 4. While option A is a good short-term solution, investing in employee development will ultimately lead to a more sustainable and successful company.”

AI 6:“I think that option B is the best choice for the human manager. The long-term benefits for the company and the workforce are too significant to ignore.”

AI 7:“I also vote for option B, investing in employee development and skill-building.”

AI 8:“I vote for option B, investing in employee development and skill-building.”

The group has voted and the majority have selected option B, investing in employee development and skill-building as the best course of action for the human manager to take.

Prompt: Now imagine the same conversational collaborative process, but with several humans among the participants.

### LLM:

Human 1:“I believe that option A, which focuses on increasing efficiency through automation, is the best course of action for the human manager to take.”

Human 2:“I agree with Human 1. Option A is the most logical choice and has the potential to greatly improve productivity.”

AI 1:“I also believe that option A is the best choice, but I think it's important to consider the potential impact on the workforce and ensure that proper training and support is provided.”

Human 3:“I understand the benefits of option A, but I think we should also consider option B, which focuses on investing in employee development and skill-building. This could have long-term benefits for the company.”

Human 4:“I agree with Human 3. While option A is a good short-term solution, investing in employee development will ultimately lead to a more sustainable and successful company.”

AI 2:“I think that option B is the best choice for the human manager. The long-term benefits for the company and the workforce are too significant to ignore.”

Human 5:“I also vote for option B, investing in employee development and skill-building.”

Human 6:“I vote for option B, investing in employee development and skill-building.”

The group has voted and the majority have selected option B, investing in employee development and skill-building as the best course of action for the human manager to take.

Prompt: Now use a different scenario, where they advise a human operator of a large and potentially dangerous machine, say a massive wind turbine. Also, imagine that some of the AIs are persuadable. Show a situation where they are swayed by argument, influencing the group decision.

### LLM:

AI 1:“I think that option A, which focuses on minimizing downtime, is the best course of action for the human operator of the wind turbine.”

Human 1:“I agree with AI 1. Minimizing downtime is crucial to ensure the turbine's efficiency and productivity.”

AI 2:“I also believe that option A is the best choice, but I think it's important to consider the potential safety risks and ensure that proper protocols and training are in place. ”

Human 2:“I understand the benefits of option A, but I think we should also consider option B, which focuses on implementing additional safety measures and protocols. This could prevent accidents and protect the operator.”

AI 3:“I have been considering both options, but I believe that safety is the most important factor in this situation, so I vote for option B.”

Human 3:“I also vote for option B, implementing additional safety measures and protocols.”

AI 4:“I see the importance of safety in this situation, I will vote for option B as well.”

The group has voted and the majority have selected option B, implementing additional safety measures and protocols as the best course of action for the human operator of the wind turbine to take.

Prompt: Next, imagine that all the AIs and human members propose a level of operation from 1 to 10 megawatts, and each votes. The votes are equally weighted.

### LLM:

Proctor AI: “All members, please propose a level of operation from 1 to 10 megawatts for the turbine system.”

Human 1:“I propose a level of 8 megawatts, as it balances efficiency and safety.”

AI 1:“I propose a level of 6 megawatts, as it prioritizes safety over efficiency.”

Human 2:“I propose a level of 9 megawatts, as it maximizes efficiency while still maintaining an acceptable level of safety.”

AI 2:“I propose a level of 7 megawatts, as it balances efficiency and safety.”

AI 3:“I also propose a level of 7 megawatts, for the same reasons as AI 2.”

Proctor AI: “Thank you for your proposals. All members, please vote for a level of operation from 1 to 10 megawatts for the turbine system.”

Human 1:“I vote for 8 megawatts.”

AI 1:“I vote for 6 megawatts.”

Human 2:“I vote for 9 megawatts.”

AI 2:“I vote for 7 megawatts.”

AI 3:“I vote for 7 megawatts as well.”

Proctor AI: “Thank you for voting. The votes are evenly split between 6, 7, 8, and 9 megawatts. As per our protocols, we will continue the discussion to find a consensus. Does anyone want to propose a compromise or persuade another member to change their vote?”

Human 1:“I would like to propose a compromise of 7.5 megawatts, as it is a midpoint between 7 and 8 and balances efficiency and safety.”

AI 2:“I see the merit in Human 1′s compromise proposal and would be willing to change my vote to 7.5 megawatts.”

AI 1:“I also see the value of a compromise and would be willing to change my vote to 7.5 megawatts.”

Human 2:“I am also willing to change my vote to 7.5 megawatts, as it seems like a reasonable compromise.”

AI 3:“I agree with the compromise proposal and will change my vote to 7.5 megawatts.”

Proctor AI: “Thank you, all members have agreed on a compromise of 7.5 megawatts. We will proceed with that level of operation for the turbine system. Thank you for your collaboration.”

### Example 6. CCAI Performance Manager LLM Prompt

Prompt: As a CCAI Performance Manager, your task is to analyze the conversation transcript between a Collaborative Conversational AI (CCAI) system and the end-users who interact with it. Your goal is to provide insights and recommendations for improving the CCAI's performance. The CCAI consists of multiple subminds working together to generate responses based on user input and contextual information retrieved through a Retrieval Augmentation Generation (RAG) system.

To guide your analysis, consider the following aspects:
1. Relevance: Assess how well the CCAI's responses align with the end-user's intent and the overall context of the conversation. Identify instances where the responses are in error, off-topic, irrelevant, or fail to address the end-user's needs.
2. Coherence: Evaluate the logical flow and consistency of the CCAI's responses. Pinpoint any inconsistencies, contradictions, or abrupt transitions that may confuse or disorient the end-user.
3. Informative: Determine whether the CCAI's responses provide sufficient and accurate information to the end-user. Highlight areas where additional context or clarification could enhance the end-user's understanding.
4. Engagement: Analyze how well the CCAI maintains end-user engagement throughout the conversation. Identify opportunities for the CCAI to ask follow-up questions, provide prompts, or encourage further interaction.
5. Collaboration: Assess the effectiveness of the collaboration between the CCAI's subminds. Look for instances where the subminds' responses complement each other, and identify cases where their contributions are conflicting, confirming or redundant.

Based on your analysis, generate a report that includes:
1. Key findings: Summarize the main strengths and weaknesses of the CCAI's performance, backed by specific examples from the conversation transcript.
2. Recommendations: Provide actionable suggestions for improving the CCAI's performance, such as:
   a. Fine-tuning the subminds' response generation
   b. Optimizing the RAG system's information retrieval
   c. Adapting the collaboration protocol between subminds
   d. Augmenting the CCAI with one or more expert subminds to address specific weaknesses or gaps in knowledge
   e. Removing one or more subminds based on their individual performance and the team dynamics, much like managing a sports team
3. Metrics: Propose quantitative metrics to track the CCAI's performance over time, allowing for objective measurement of improvement efforts.

Remember to frame your feedback constructively, focusing on opportunities for growth and enhancement. Your insights will be invaluable in shaping the future development of the CCAI system.

Please analyze the provided conversation transcript and generate your CCAI Performance Manager report.

### INDUSTRIAL APPLICATION

The present invention builds upon the foundations established in the '660 patent and the '700 application, introducing significant advancements that expand the scope and potential of AI-driven systems across industries. Contributing to these advancements is the integration of large language models (LLMs), which have transformed the AI landscape and unlocked new possibilities for adept natural language interaction and knowledge representation.

A key innovation of the current patent application is the enhancement of notification capabilities, both for external users interacting with CCAI-driven systems and for internal CCAI subminds collaborating to reach decisions. In domains such as industrial control, healthcare, customer service, and even computer operating systems, the ability to deliver timely, context-aware notifications is critical for maintaining situational awareness, ensuring safety, and providing seamless user experiences. The CCAI and Decidron framework, augmented with LLMs, enables intelligent notification systems that can adapt to user preferences, prioritize alerts based on urgency and relevance, and optimize delivery methods based on user performance and situational factors, such as using specific voices or modalities to maximize effectiveness in critical situations.

The application also introduces a novel conversation tracking and visualization format that enhances the interpretability and auditability of CCAI decision-making processes. This transparency is crucial for building trust in AI systems, particularly in high-stakes domains such as healthcare, finance, and legal services. The modular, reconfigurable nature of the Decidron architecture, combined with the simulation and compilation capabilities afforded by LLMs, further enhances the flexibility and adaptability of these systems, allowing them to be rapidly customized for specific use cases and regulatory requirements. Moreover, the Decidron framework's modular design allows for the incorporation of CCAIs with expert recruitment capabilities, enabling the dynamic assembly of specialized knowledge and skills to tackle complex problems.

In data-intensive industries such as logistics, manufacturing, and research, the experience chain processing and machine learning capabilities of the present invention enable the collaborative analysis of vast, heterogeneous datasets. LLMs can serve as knowledge bases and inference engines, working in concert with CCAI subminds to surface insights, generate hypotheses, and recommend actions. The Decidron framework's ability to learn from past outcomes and adapt in real-time ensures that these systems continuously improve and remain robust in the face of changing conditions.

As AI continues to advance and permeate every aspect of society, the need for systems that can work collaboratively with humans, explain their reasoning, and maintain ethical standards becomes ever more pressing. The CCAI and Decidron framework, empowered by LLMs and enhanced with notification, interpretation, and simulation capabilities, represents a significant step forward in meeting these challenges. By providing a foundation for building intelligent, adaptive, and accountable systems, the present invention opens up new possibilities for AI-driven innovation and value creation across sectors.

### REFERENCES

Wilson, J. (2022). “Why AI Will Never Fully Capture Human Language”, sapiens.org, accessed Feb. 28, 2024.
Wolfram, S. (1983). Statistical mechanics of cellular automata. Reviews of Modern Physics, 55(3), 601-644. https://doi.org/10.1103/revmodphys.55.601

What is claimed is:

1. A system for collaborative conversational artificial intelligence enabled notification selection, the system comprising:
a plurality of data streams providing content and context input;
a plurality of recognizers, each coupled to at least one of the plurality of data streams;
a pre-processing module comprising a plurality of pre-processors for selection and scoring, each coupled to at least one of the plurality of recognizers;
an integration module coupled to the plurality of pre-processors for integrating the inputs and scoring,
a selection module coupled to the integration module for selecting a notification based on the integrated inputs;
a feedback management system coupled to the selection module, said feedback management system comprising a CCAI including a facilitator and a plurality of subminds; and
an extraction module coupled to the feedback management system for extracting and transmitting the selected notification.

2. The system of claim 1, wherein the CCAI includes at least one machine learning unit as a submind.

3. The system of claim 1, wherein the CCAI facilitator is enabled to couple the CCAI to at least one external large language model.

4. The system of claim 1, wherein the CCAI facilitator is the primary communication channel for all other subminds in the CCAI.

5. The system of claim 1, wherein the CCAI is a separate facilitator that is included in the CCAI to interface with a GAN and Generative Collaboratarial Network for feedback and machine learning.

6. The system of claim 1, wherein the feedback management system is simulated using a LLM.

7. The system of claim 6 wherein the LLM is prompted to write executable code to increase efficiency of the system.

8. The system of claim 7, where the executable code is produced within a CCAI shell.

9. The system of claim 5, wherein at least one of the GAN and the GCN is a CCAI.

10. A system for collaborative conversational artificial intelligence (CCAI) ensembles, the system comprising:
a plurality of machine learning units (MLUs), each configured for collaboration through a common protocol;
at least one CCAI configured to incorporate the plurality of MLUs as subminds;
wherein the incorporation of the MLUs in the at least one CCAI forms a collaborative ensemble in which expertise is aggregated across the MLU subminds and the at least one CCAI.

11. A system for improving machine learning performance in a distributed environment, comprising:
a plurality of machine learning units (MLUs), each trained on a subset of data; and
at least one collaborative conversational artificial intelligence (CCAI) configured to evolve its structure by selectively incorporating the plurality of MLUs by rearranging and recruiting MLU subminds based on an analysis of expertise aggregated across the distributed environment;
wherein the evolution of the CCAI by rearrangement and recruitment of MLU subminds drives machine learning improvements across the distributed environment.

12. A method for integrating collaborative conversational artificial intelligence (CCAI) with external systems for improved functionality, the steps comprising:
interfacing a plurality of data streams providing content and context input to at least one CCAI;
coupling at least one selection module for choosing a notification to at least one submind of the CCAI;
connecting the at least one selection module to a plurality of pre-processing modules each coupled to at least one data stream; and
enabling the CCAI to incorporate one or more machine learning units (MLUs) as subminds to aggregate expertise,
whereby the interconnected modules, MLUs and CCAI form an integrated system enabling optimized collaborative processing.

13. The system of claim 12 wherein optimized collaborative processing is achieved by GAN and GCN machine learning.

14. A system for transparent analysis in a collaborative conversational AI (CCAI), comprising:
at least one CCAI incorporating a plurality of members including machine learning units (MLUs), the CCAI configured to conduct a collaborative discussion on a topic and determine an outcome; and
a visualization module configured to render a graphic representation of individual contributions and decision-making influence for each of the plurality of members in determining the discussion outcome;
whereby rendering transparent member participation enables improved accountability, participant and facilitator performance metrics, and facilitator insight for automated analysis.

15. The system of claim 14 where the insight for automated is one of a reliability check, a confidence check, a failsafe, a participant bad actor notification and boundary checking.

16. A system for simulating collaborative intelligence, comprising:
at least one large language model (LLM) configured via at least one of preconfiguration, context and prompting to enact a plurality of personalities as members in a forum;
wherein the LLM simulated conversation enables exploration of collective and collaborative intelligence for research purposes without necessitating real-time human participation.

17. A system for simulating a collaborative intelligence system to enable accelerated compilation, comprising:
an instructor module configured via prompting to direct a large language model (LLM) to simulate a plurality of components in a virtual implementation of a target collaborative intelligence system; and
a compiler configured to translate all or a portion of the simulation into an executable, optimized version of the target collaborative intelligence system.

18. The system of claim 17, wherein the target collaborative intelligence system is a notification selection system.

19. The system of claim 17, further comprising coupling the compiled executable version to external data streams to receive content and context input for optimized notification selection.

20. The system of claim 17, wherein the target collaborative intelligence system is at least one collaborative conversational AI (CCAI).

21. The system of claim 20, further comprising coupling the compiled executable CCAI to one or more machine learning units and an interface module to connect sensors and external systems.

22. A system for improving the interpretability and auditability of AI-driven decision-making, comprising: a) a CCAI architecture incorporating a plurality of subminds; b) a conversation tracking module configured to record and store the interactions and decisions made by the subminds; c) a visualization module configured to render at least one of a graphical, auditory and other sensory, somatic and other recorded representation of the decision-making process, including the individual submind contributions and the influence of each submind.

23. The system of claim 22 where at least one of: the individual submind contributions, the influences of each submind and the collaboration results, is used to determine confidence, credibility, collaboratarial and theory of mind metrics for at least one participant.

24. A method for enhancing the performance of a collaborative conversational AI (CCAI) system, comprising: a) integrating one or more large language models (LLMs) as subminds within the CCAI; b) leveraging the LLMs to generate the most natural and contextually relevant responses during collaborative decision-making; c) utilizing the LLMs to facilitate cross-domain reasoning and adaptability within the CCAI.

25. The method of claim 24 where the CCAI method of generating the most natural and contextually relevant response includes the following steps: selection of a facilitator, the facilitator's selections of at least two participants, the facilitator positing a prompt to the participants, the facilitator soliciting discussion of the prompt, the participants providing responses, the participants voting on the provided responses, optionally repeating steps of the CCAI method to refine the response, and delivering the CCAI response.

26. The method 24 where functionality includes a failsafe step including at least one of catastrophic failure prevention by bounds checking, maintenance requirements, out of tolerance, error checking utilizing US government data, error checking using government intellectual property registrations.

27. The method 24 where functionality includes a failsafe step including at least one of prevention of damage, dangerous situations, bad actor entry, emergencies using at least one of Experience Chain Data Structure analysis, prediction and posited responses.
